(19) United States
(12) Patent Application Publication
(10) Pub. No.: US 2012/0027342 A1
(43) Pub. Date: Feb. 2, 2012

(54) CATION-POLYMERIZABLE RESIN COMPOSITION AND CURED PRODUCT THEREOF

(76) Inventors: Tsukasa Yoshida, Hyogo (JP); Yoshinori Funaki, Hyogo (JP); Yo Yamato, Hyogo (JP)

(21) Appl. No.: 13/260,880

(22) PCT Filed: Mar. 30, 2010
(86) PCT No.: PCT/JP2010/055743

§ 371 Date: Sep. 28, 2011

(30) Foreign Application Priority Data
Apr. 6, 2009 (JP) 2009-092178

(51) Int. Cl. G02B 6/12; B29C 59/02; B05D 5/06; C08F 279/02; C08G 64/02

(52) U.S. Cl. 385/14; 525/286; 525/284; 528/370; 427/162; 264/293

(57) ABSTRACT

Provided is a cationically polymerizable resin composition which has a low viscosity, is easy to work, and is extremely rapidly cured upon irradiation with light to give a cured product excellent in optical transparency, flexibility, thermal stability, and post-heating bendability.

The cationically polymerizable resin composition includes an oxetane-ring-containing vinyl ether compound (A) and/or an alicyclic-epoxy-group-containing vinyl ether compound (B); an oligomer or polymer (C) containing, in the molecule, at least one selected from oxetane group, epoxy group, hydroxyl group, vinyl ether group, and an aliphatic or alicyclic unsaturated hydrocarbon group and having a molecular weight of 500 or more; and an oxetane compound (D) containing no vinyl ether group and having 6 or more carbon atoms.

### TECHNICAL FIELD

The present invention relates to a cationically polymerizable resin composition and a cured product thereof, which cationically polymerizable resin composition (cation-polymerizable resin composition) is useful in waveguides (e.g., optical waveguides and opto-electric hybrid circuit boards), optical fibers, optically transparent sealants, ink-jet inks, color filters, nanoimprinting processes, and flexible boards and is particularly useful in flexible optical waveguides, optically transparent sealants, and nanoimprinting processes. The present invention also relates to a method for producing an optical waveguide using the cationically polymerizable resin composition; an optical waveguide produced by the method; an opto-electric hybrid circuit board including the optical waveguide and, arranged thereon, an electric wiring; and a method for producing a fine structure using the cationically polymerizable resin composition.

### BACKGROUND ART

In recent high-speed, high-density signal transmission between electronic devices or between circuit boards, a customary transmission technique through electric wirings has began to reveal limitations in realization of high speed and high density, because mutual interference between signals and electromagnetic noise from surroundings constitute barriers. In order to overcome such limitations, a technology for optically connecting between electronic devices or between circuit boards, a so-called optical interconnection, is being examined. A flexible optical waveguide having satisfactory flexibility has been considered to be suitable as an optical path because of easy connection between devices or between circuit boards and satisfactory handleability.

Customary flexible optical waveguides have employed epoxy compounds. Such epoxy compounds, however, show poor polymerization reactivity (curability), high skin irritation potential, and high toxicity and thereby have disadvantages in handleability and safety, although they give cured products which excel in chemical resistance and adhesion. Independently, there has been an attempt to adopt polyimides to flexible optical waveguides, but the attempt has proved as being limited, because the polyimides should be prepared at high temperatures; they are significantly limited in solvents when they are handled as polymers to form polymer solutions; and they are very expensive.

Japanese Unexamined Patent Application Publication (JP-A) No. H10-25262 and Japanese Unexamined Patent Application Publication (JP-A) No. 2003-73321 disclose some alicyclic vinyl ether compounds as polymerizable compounds. These compounds show low skin irritation potential and thereby have improved safety, but are still insufficient in thermal stability and optical transparency and are susceptible to improvements.

Japanese Unexamined Patent Application Publication (JP-A) No. H10-316670 discloses a vinyl ether compound containing an oxetane ring in the molecule. This compound, however, is not always satisfactory, because the compound, when having a long glycol chain, gives a cured product having flexibility but showing insufficient thermal stability and optical transparency; and the compound, when having a short glycol chain, gives a cured product having insufficient flexibility. Japanese Unexamined Patent Application Publication (JP-A) No. H07-233112 and Japanese Unexamined Patent Application Publication (JP-A) No. H11-171967 disclose vinyl ether compounds each containing, in the molecule, an alicyclic epoxy group composed of a cyclohexane ring and an oxirane ring bonded to each other. The compounds, however, show poor flexibility and are difficult to be adopted to flexible optical waveguides and other uses where flexibility is required, although they excel in thermal stability, optical transparency, and curing rate.

Likewise, Japanese Patent Application No. 2007-078858 and Japanese Patent Application No. 2007-076219 disclose an alicyclic-epoxy-group-containing vinyl ether compound and an oxetane-ring-containing vinyl ether compound, respectively. These compounds also show poor flexibility and are difficult to be adopted to flexible optical waveguides and other uses where flexibility is required, although they excel in thermal stability, optical transparency, and curing rate. Japanese Unexamined Patent Application Publication (JP-A) No. 2006-232988 discloses an example (ink) in which a cyclic ether compound containing a vinyl ether structure is added with an epoxidized polybutadiene having hydroxyl groups at both terminals. The resulting composition, however, contains vinyl ether group alone as a reactive group and is thereby inferior in thermal stability and optical transparency to a vinyl ether containing a reactive cyclic ether in the molecule.

### CITATION LIST

### Patent Literature

PTL 1: Japanese Unexamined Patent Application Publication (JP-A) No. H10-25262
PTL 2: Japanese Unexamined Patent Application Publication (JP-A) No. 2003-73321
PTL 3: Japanese Unexamined Patent Application Publication (JP-A) No. H10-316670
PTL 4: Japanese Unexamined Patent Application Publication (JP-A) No. H07-233112
PTL 5: Japanese Unexamined Patent Application Publication (JP-A) No. H11-171967
PTL 6: Japanese Patent Application No. 2007-078858
PTL 7: Japanese Patent Application No. 2007-076219
PTL 8: Japanese Unexamined Patent Application Publication (JP-A) No. 2006-232988

### SUMMARY OF INVENTION

### Technical Problem

Accordingly, an object of the present invention is to provide a cationically polymerizable resin composition and a cured product thereof, which resin composition has a low viscosity, is easy to work, and is extremely rapidly cured upon irradiation with light to give a cured product with excellent optical transparency, flexibility, thermal stability, and post-heating bendability (bendability after heating). The cationically polymerizable resin composition according to the present invention is useful typically in optical fibers, optically transparent sealants, ink-jet inks, color filters, nanoimprinting technologies, and flexible boards and is particularly useful in flexible optical waveguides, optically transparent sealants, and nanoimprinting.

Another object of the present invention is to provide a method for efficiently producing an optical waveguide using the cationically polymerizable resin composition; an optical waveguide produced by the production method; an opto-electric hybrid circuit board including the optical waveguide and an electric wiring present on or above a surface of the optical waveguide; and a method for efficiently producing a fine structure using the cationically polymerizable resin composition.

### Solution to Problem

After intensive investigations to achieve the objects, the present inventors have found a cationically polymerizable resin composition containing a vinyl ether compound having a cationically polymerizable cyclic ether, a compound having a functional group being reactive with the vinyl ether compound, and an oxetane compound containing no vinyl ether group and having 6 or more carbon atoms; and have found that this cationically polymerizable resin composition has a low viscosity, is easy to work, and is extremely rapidly cured to give a cured product with excellent optical transparency, flexibility, thermal stability, and post-heating bendability. The present invention has been made based on these findings.

Specifically, the present invention provides a canonically polymerizable resin composition including a vinyl ether compound (A) and/or a vinyl ether compound (B), the vinyl ether compound (A) containing an oxetane ring, and the vinyl ether compound (B) containing an alicyclic epoxy group; an oligomer or polymer (C) having a molecular weight of 500 or more and containing at least one selected from the group consisting of oxetane group, epoxy group, hydroxyl group, vinyl ether group, and an aliphatic or alicyclic unsaturated hydrocarbon group in the molecule; and an oxetane compound (D) containing no vinyl ether group and having 6 or more carbon atoms.

The oligomer or polymer (C) is preferably an oligomer or polymer containing a terminal hydroxyl group or a terminal hydrogen atom, having a molecular weight of 500 or more, and comprising at least one structure selected from the group consisting of structures represented by following Formulae (1a), (1b), (1c), and (1d):

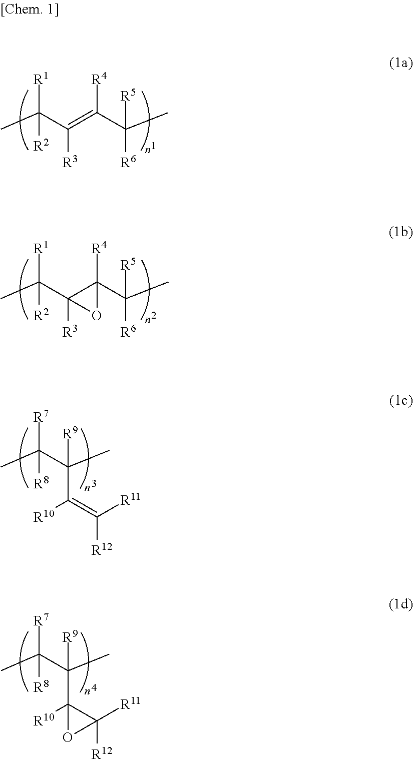

wherein R¹, R², R³, R⁴, R⁵, R⁶, R⁷, R⁸, R⁹, R¹⁰, R¹¹, and R¹² each represent a hydrogen atom or a substituted or unsubstituted hydrocarbon group having 1 to 20 carbon atoms; and n¹, n², n³, and n⁴ each denote an integer of 1 or more, or the oligomer or polymer (C) is preferably an oligomer or polymer containing a terminal hydroxyl group or a terminal hydrogen atom, having a molecular weight of 500 or more, and having a structure represented by following Formula (1e):

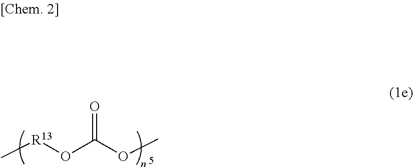

wherein R¹³ represents a substituted or unsubstituted divalent hydrocarbon group; and n⁵ denotes an integer of 1or more. More preferably, the oligomer or polymer (C) is an oligomer or polymer having at least an epoxy group and an aliphatic or alicyclic unsaturated hydrocarbon group; or is a polycarbonate polyol, or an epoxidized polybutadiene having hydroxyl groups at both terminals.

The oxetane compound (D) containing no vinyl ether group and having 6 or more carbon atoms is preferably a compound represented by following Formula (2):

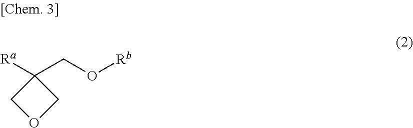

wherein R^{a} represents a hydrocarbon group; and R^{b} represents a hydrocarbon group other than a vinyl group.

The cationically polymerizable resin composition may be used for the production of an optical waveguide, for an optically transparent sealant, and for nanoimprinting use.

The present invention provides, in another aspect, a cured product obtained through polymerization of the cationically polymerizable resin composition.

The cured product preferably forms a clad and/or a core of an optical waveguide.

The present invention also provides, in yet another aspect, a method for producing an optical waveguide by applying the cationically polymerizable resin composition to a film to give a clad base film, and covering a core with the clad base film.

The present invention further provides, in still another aspect, an optical waveguide produced by the method for producing an optical waveguide.

The present invention provides, in another aspect, an opto-electric hybrid circuit board including the optical waveguide and an electric wiring present on or above at least one surface of the optical waveguide.

The present invention provides, in yet another aspect, an opto-electric hybrid circuit board including the optical waveguide, an electric wiring, and a porous layer present between the optical waveguide and the electrical wiring.

The porous layer is preferably a porous layer prepared by casting a polymer solution as a film onto a substrate or carrier; introducing the cast film into a coagulation liquid to coagulate the cast film; and drying the coagulated film.

The electric wiring may be formed through plating, printing, or etching.

The present invention also provides, in still another aspect, a method for producing a fine structure by subjecting the cationically polymerizable resin composition to nanoimprinting.

### ADVANTAGEOUS EFFECTS OF INVENTION

The cationically polymerizable resin composition according to the present invention includes an oxetane-ring-containing vinyl ether compound (A) and/or an alicyclic-epoxy-group-containing vinyl ether compound (B); an oligomer or polymer (C); and an oxetane compound (D), in which the oxetane-ring-containing vinyl ether compound (A) and the alicyclic-epoxy-group-containing vinyl ether compound (B) each contain a cationically polymerizable cyclic ether (i.e., oxetane ring or alicyclic epoxy group) and a vinyl ether group in the same molecule, the oligomer or polymer (C) has at least one functional group (i.e., oxetane group, epoxy group, hydroxyl group, vinyl ether group, or an aliphatic or alicyclic unsaturated hydrocarbon group) reactive with the cationically polymerizable cyclic ether and has a molecular weight of 500 or more, and the oxetane compound (D) contains no vinyl ether group and has 6 or more carbon atoms. The cationically polymerizable resin composition thereby has a low viscosity, is easy to work, and is curable extremely rapidly upon irradiation with light. This effectively gives a cured product with higher productivity. The cationically polymerizable resin composition gives, through curing, a cured product having satisfactory optical transparency, flexibility, thermal stability, and post-heating bendability and is excellent as an optical material. Because of satisfactory flexibility of its cured product, the cationically polymerizable resin composition enables easy connection between devices and between substrates and shows satisfactory handleability and workability. In addition, the cationically polymerizable resin composition shows low toxicity and low skin irritation potential and is highly safe. For these reasons, the cationically polymerizable resin composition is advantageously usable typically in optical fibers, optically transparent sealants, ink-jet inks, color filters, nanoimprinting technologies, and flexible boards and is particularly advantageously usable in flexible optical waveguides, optical fibers, optically transparent sealants, and nanoimprinting technologies.

### DESCRIPTION OF EMBODIMENTS

### Oxetane-Ring-Containing Vinyl Ether Compound (A)

The oxetane-ring-containing vinyl ether compound (A) for use in the present invention is not limited, as long as being a compound containing at least an oxetane ring and a vinyl ether structure in the molecule. Representative examples of the oxetane-ring-containing vinyl ether compound (A) include compounds each represented by following Formula (3):

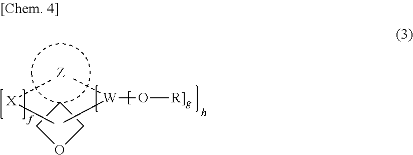

wherein Ring Z represents a nonaromatic carbocyclic ring which forms a Spiro structure with oxetane ring and which may be present or absent in the molecule; R represents a substituted or unsubstituted vinyl group represented by following Formula (4):

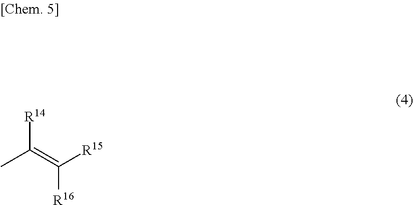

wherein R¹⁴, R¹⁵, and R¹⁶ are the same as or different from one another and each represent a hydrogen atom or an alkyl group having 1 to 4 carbon atoms;
W is a linkage group connecting between the substituted or unsubstituted vinyloxy group (—OR group) and the oxetane ring or Ring Z and represents a single bond or an organic group having a valency of (g+1); X is a substituent of the oxetane ring and Ring Z and represents a halogen atom, a substituted or unsubstituted hydrocarbon group, a protected or unprotected hydroxyl group, a protected or unprotected amino group, a protected or unprotected carboxyl group, a protected or unprotected sulfo group, an oxo group, a nitro group, a cyano group, or a protected or unprotected acyl group; “g” denotes 1 or 2; “f” denotes an integer of 0 to 5; and “h” denotes 1 or 2, wherein, when “g”, “f”, and/or “h” is 2 or more, two or more substituents in the brackets may be the same as or different from each other.

When “g” and “h” are both 1 in the compounds, it is preferred that at least Ring Z is present; or X contains an aromatic or nonaromatic carbocyclic ring; or W contains an aromatic or nonaromatic carbocyclic ring.

The oxetane-ring-containing vinyl ether compound (A) for use herein preferably further has an aromatic or nonaromatic carbocyclic ring in the molecule, or has two or more vinyl ether structures in the molecule. Such an oxetane-ring-containing vinyl ether compound further containing a carbocyclic ring in the molecule or further containing two or more vinyl ether structures in the molecule not only is curable extremely rapidly but also gives, through curing, a cured product having satisfactory properties such as optical transparency and thermal stability, thus being significantly advantageous.

In the oxetane-ring-containing vinyl ether compound (A), exemplary aromatic carbocyclic rings include benzene ring and naphthalene ring. Exemplary nonaromatic carbocyclic rings include cycloalkane rings such as cyclopropane ring, cyclobutane ring, cyclopentane ring, cyclohexane ring, cyclooctane ring, and cyclododecane ring, of which cycloalkane rings each having about 3 to about 15 members are preferred; and bridged alicyclic rings each having about 6 to about 20 carbon atoms, such as decalin ring, adamantane ring, and norbornane ring. Two or more aromatic or nonaromatic carbocyclic rings may be present in the molecule. The aromatic or nonaromatic carbocyclic ring(s) is often present at a linkage moiety connecting between the vinyl ether structure and the oxetane ring. The nonaromatic carbocyclic ring may form a Spiro structure with the oxetane ring.

The oxetane-ring-containing vinyl ether compound (A) for use in the present invention has only to have one vinyl ether structure when having an aromatic or nonaromatic carbocyclic ring (Ring Z), and does not have to have an aromatic or nonaromatic carbocyclic ring when having two or more vinyl ether structures. However, the oxetane-ring-containing vinyl ether compound (A) may also be one having an aromatic or nonaromatic carbocyclic ring and further having two or more vinyl ether structures per molecule.

In Formula (3), examples of the nonaromatic carbocyclic ring as Ring Z include the above-exemplified nonaromatic carbocyclic rings. Ring Z is preferably cyclopentane ring or cyclohexane ring.

In Formula (3), R represents a substituted or unsubstituted vinyl group represented by Formula (4). In Formula (4), R¹⁴, R¹⁵, and R¹⁶ are the same as or different from one another and each represent a hydrogen atom or an alkyl group having 1 to 4 carbon atoms. Exemplary alkyl groups each having 1 to 4 carbon atoms include linear alkyl groups having 1 to 4 carbon atoms, such as methyl, ethyl, propyl, and butyl groups, of which those each having 1 to 3 carbon atoms are preferred; and branched chain alkyl groups each having 1 to 4 carbon atoms, such as isopropyl, isobutyl, s-butyl, and t-butyl groups, of which those each having 1 to 3 carbon atoms are preferred. R¹⁴, R¹⁵, and R¹⁶ are each particularly preferably a hydrogen atom or methyl group. Representative examples of the group represented by Formula (4) include vinyl group, isopropenyl group, 1-propenyl group, 2-methyl-1-propenyl group, and 1,2-dimethyl-1-propenyl group.

In Formula (3), W is a linkage group connecting between the substituted or unsubstituted vinyloxy group (—OR group) and the oxetane ring or Ring Z and represents a single bond or an organic group having a valency of (g+1). The organic group is generally a group having a carbon atom at the bonding site with the adjacent oxygen atom. Preferred examples of the organic group include (i) hydrocarbon groups, and (ii) groups each composed of one or more hydrocarbon groups and at least one group selected from oxygen atom (—O—), sulfur atom (—S—), carbonyl group (—CO—), and amino group (—NH—).

The hydrocarbon groups include aliphatic hydrocarbon groups, alicyclic hydrocarbon groups, aromatic hydrocarbon groups, and hydrocarbon groups each composed of two or more of these bonded to each other.

When taking divalent hydrocarbon groups as an example, exemplary hydrocarbon groups include linear or branched chain alkylene groups each having 1 to about 20 carbon atoms, such as methylene, methylmethylene (ethylidene), ethylmethylene (propylidene), dimethylmethylene (isopropylidene), ethylmethylmethylene, ethylene, propylene, trimethylene, tetramethylene, and hexamethylene groups, of which those each having 1 to 10 carbon atoms are preferred, and those each having 1 to about 6 carbon atoms are more preferred; linear or branched chain alkenylene groups each having 2 to about 20 carbon atoms, such as propenylene group, of which those each having 2 to about 10 carbon atoms are preferred, and those each having 2 to about 6 carbon atoms are more preferred; cycloalkylene groups each having 3 to about 20 members, such as 1,3-cyclopentylene, 1,2-cyclohexylene, 1,3-cyclohexylene, and 1,4-cyclohexylene groups, of which those each having 3 to about 15 members are preferred, and those each having about 5 to about 8 members are more preferred; cycloalkylidene groups each having 3 to about 20 members, such as cyclopropylene, cyclopentylidene, and cyclohexylidene groups, of which those each having 3 to about 15 members are preferred, and those each having about 5 to about 8 members are more preferred; arylene groups such as 1,2-phenylene, 1,3-phenylene, and 1,4-phenylene groups; and benzylidene group.

The hydrocarbon groups may be substituted with one or more substituents. Exemplary substituents include protected or unprotected hydroxyl groups, protected or unprotected hydroxymethyl groups, protected or unprotected amino groups, protected or unprotected carboxyl groups, protected or unprotected sulfo groups, halogen atoms, oxo groups, cyano groups, nitro groups, heterocyclic groups, hydrocarbon groups, and haloalkyl groups. Protecting groups for use herein may be protecting groups customarily used in organic syntheses.

Exemplary heterocyclic groups as the substituents include heterocyclic groups each containing at least one heteroatom selected from nitrogen atoms, oxygen atoms, and sulfur atoms and having 3 to about 15 members, of which heterocyclic groups each having 5 to 8 members are preferred.

Hydrocarbon groups as the substituents include aliphatic hydrocarbon groups, alicyclic hydrocarbon groups, aromatic hydrocarbon groups, and groups each composed of two or more of these bonded to each other. Exemplary aliphatic hydrocarbon groups include alkyl groups each having 1 to about 20 carbon atoms, of which those each having 1 to about 10 carbon atoms are preferred, and those each having 1 to about 3 carbon atoms are more preferred; alkenyl groups each having 2 to about 20 carbon atoms, of which those each having 2 to about 10 carbon atoms are preferred, and those each having approximately 2 or 3 carbon atoms are more preferred; and alkynyl groups each having 2 to about 20 carbon atoms, of which those each having 2 to about 10 carbon atoms are preferred, and those each having approximately 2 or 3 carbon atoms are more preferred. Exemplary alicyclic hydrocarbon groups include cycloalkyl groups each having 3 to about 20 members, of which those each having 3 to about 15 members are preferred, and those each having about 5 to about 8 members are more preferred; cycloalkenyl groups each having 3 to about 20 members, of which those each having 3 to about 15 members are preferred, and those each having about 5 to about 8 members are more preferred; and bridged hydrocarbon groups such as perhydronaphth-1-yl group, norbornyl, adamantyl, and tetracyclo[4.4.0.1^{2,5}. 1^{7,10}]dodec-3-yl group. Exemplary aromatic hydrocarbon groups include aromatic hydrocarbon groups each having about 6 to about 14 carbon atoms, of which those each having about 6 to about 10 carbon atoms are preferred. Exemplary hydrocarbon groups each composed of an aliphatic hydrocarbon group and an alicyclic hydrocarbon group bonded to each other include cycloalkyl-alkyl groups such as cyclopentylmethyl, cyclohexylmethyl, and 2-cyclohexylethyl groups, of which preferred are cycloalkyl-alkyl groups whose cycloalkyl moiety having 3 to 20 carbon atoms and whose alkyl moiety having 1 to 4 carbon atoms. Exemplary hydrocarbon groups each composed of an aliphatic hydrocarbon group and an aromatic hydrocarbon group bonded to each other include aralkyl groups such as aralkyl groups each having 7 to 18 carbon atoms; and alkyl-substituted aryl groups such as phenyl group or naphthyl group substituted with one to about four alkyl groups each having 1 to 4 carbon atoms.

Exemplary haloalkyl groups as the substituents include haloalkyl groups each having 1 to 10 carbon atoms, such as chloromethyl, trifluoromethyl, 2,2,2-trifluoroethyl, and pentafluoroethyl groups, of which haloalkyl groups each having 1 to 3 carbon atoms are preferred.

Preferred examples of W include groups each represented by following Formula (5):

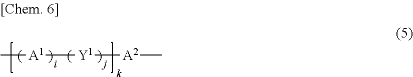

wherein A¹ represents a divalent hydrocarbon group; Y¹ represents an oxygen atom (—O—), a sulfur atom (—S—), a carbonyl group (—CO—), an amino group (—NH—), or a group composed of two or more of these bonded to each other; A² represents a single bond or a hydrocarbon group having a valency of (g+1), where A² is bonded to —OR in Formula (3); “i” and “j” each denote 0 or 1; and “k” denotes an integer of 0 to 5.

Exemplary divalent hydrocarbon groups as A¹ are as mentioned above. Among them, preferred as A¹ are linear or branched chain alkylene groups each having 1 to 6 carbon atoms, such as methylene, ethylene, propylene, isopyropylidene, trimethylene, and tetramethylene groups.

Y¹ is preferably, for example, oxygen atom (—O—), sulfur atom (—S—), carbonyl group (—CO—), amino group (—NH—), —COO—, —COO—, —CONH—, or —NHCO—.

Exemplary hydrocarbon groups each having a valency of (g+1) as A² are as mentioned above. Among them, preferred examples as A² include single bond; linear or branched chain alkylene groups each having 1 to 6 carbon atoms, such as methylene, ethylene, propylene, isopyropylidene, trimethylene, and tetramethylene groups, cycloalkylene groups each having 5 to 8 members, such as 1,3-cyclopentylene, 1,2-cyclohexylene, 1,3-cyclohexylene, and 1,4-cyclohexylene groups, cycloalkylidene groups each having 5 to 8 members, such as cyclopropylene, cyclopentylidene, and cyclohexylidene groups, arylene groups such as 1,2-phenylene, 1,3-phenylene, and 1,4-phenylene groups, and groups each composed of two or more of these bonded to each other.

W is particularly preferably a single bond, or a linear or branched chain alkylene group having 1 to 6 carbon atoms, or a group composed of the alkylene group and an oxygen atom or sulfur atom bonded to each other.

In Formula (3), X is a substituent of the oxetane ring and Ring Z and represents a halogen atom, a substituted or unsubstituted hydrocarbon group, a protected or unprotected hydroxyl group, a protected or unprotected amino group, a protected or unprotected carboxyl group, a protected or unprotected sulfo group, an oxo group, a nitro group, a cyano group, or a protected or unprotected acyl group. Exemplary protecting groups for use herein include protecting groups customarily used in organic syntheses.

Exemplary halogen atoms as X include fluorine, chlorine, and bromine atoms. Exemplary hydrocarbon groups in the “substituted or unsubstituted hydrocarbon group” as X include aliphatic hydrocarbon groups such as methyl, ethyl, propyl, isopropyl, butyl, isobutyl, s-butyl, t-butyl, hexyl, octyl, and decyl groups, of which alkyl groups each having 1 to 10 carbon atoms are preferred, and alkyl groups each having 1 to 5 carbon atoms are more preferred; alicyclic hydrocarbon groups such as cyclopentyl and cyclohexyl groups, of which cycloalkyl groups each having 3 to 15 members are preferred; aromatic hydrocarbon groups such as phenyl and naphthyl groups; and groups each composed of two or more of these bonded to each other. Exemplary substituents which these hydrocarbon groups may have include halogen atoms such as fluorine, chlorine, and bromine atoms; alkyl groups each having 1 to 4 carbon atoms, such as methyl group; haloalkyl groups each having 1 to 5 carbon atoms, such as trifluoromethyl group; hydroxyl group; alkoxy groups each having 1 to 4 carbon atoms, such as methoxy group; amino group; dialkylamino groups; carboxyl group; alkoxycarbonyl groups such as methoxycarbonyl group; nitro group; cyano group; and acyl groups such as acetyl group.

Exemplary acyl groups as X include aliphatic acyl groups each having 1 to 6 carbon atoms, such as formyl, acetyl, propionyl, butyryl, isobutyryl, and pivaloyl groups; acetoacetyl group; and aromatic acyl groups such as benzoyl group.

When there are two or more Xs, they may be bound to each other to form a ring with a carbon atom constituting Ring Z or the oxetane ring in Formula (3). Examples of such rings include alicyclic carbocyclic rings such as cyclopentane ring, cyclohexane ring, and perhydronaphthalene ring (decalin ring); and lactone rings such as γ-butyrolactone ring and δ-valerolactone ring.

In Formula (3), “g” denotes 1 or 2 and is preferably 1. The number “f” denotes an integer of 0 to 5 and is preferably an integer of 0 to 3. The number “h” denotes 1 or 2. When “f”, “g”, and/or “h” is 2 or more, two or more substituents in the brackets may be the same as or different from each other. When “g” and “h” are both 1, it is preferred that at least Ring Z is present, or X contains an aromatic or nonaromatic carbocyclic ring, or W contains an aromatic or nonaromatic carbocyclic ring.

Of the compounds represented by Formula (3), preferred are compounds represented by following Formulae (3a), (3b), (3c), or (3d):

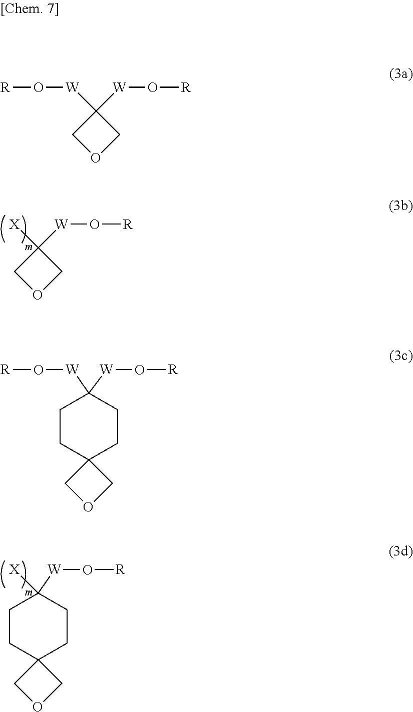

wherein “m” denotes 0 or 1; R, W, and X are as defined above, and wherein at least one of W and X in Formula (3b) contains an aromatic or nonaromatic carbocyclic ring.

Representative examples of the oxetane-ring-containing vinyl ether compound (A) for use herein include compounds represented by following formulae. In the following formulae, “n” denotes an integer of 0 to 6.

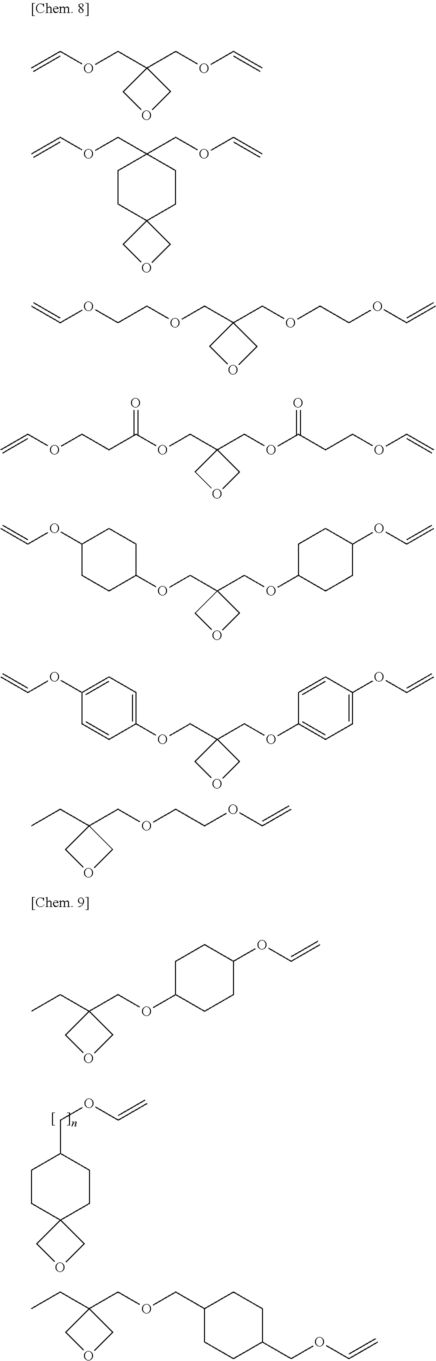

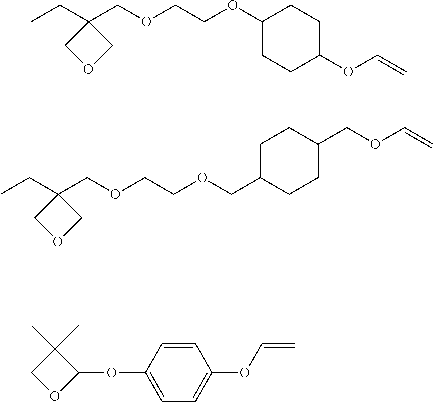

The oxetane-ring-containing vinyl ether compound (A) for use herein may be prepared by using a reaction known as a production process of a vinyl ether compound. In a preferred embodiment, the oxetane-ring-containing vinyl ether compound (A) is prepared by a process of reacting an alcohol (hydroxy compound) corresponding to the oxetane-ring-containing vinyl ether compound (A) with a vinyl ester compound in the presence of a transition element compound. Typically, an oxetane-ring-containing vinyl ether compound (A) represented by Formula (3) may be prepared by reacting a corresponding alcohol (hydroxy compound), wherein R in Formula (3) is a hydrogen atom, with a vinyl ester compound in the presence of a transition element compound.

[Alicyclic-Epoxy-Group-Containing Vinyl Ether Compound (B)]

The alicyclic-epoxy-group-containing vinyl ether compound (B) for use in the present invention is not limited, as long as being a compound containing at least an alicyclic epoxy group (group composed of an epoxy ring and an alicyclic ring possessing two carbon atoms in common) and a vinyl ether structure in the molecule. Representative examples of the alicyclic-epoxy-group-containing vinyl ether compound (B) include compounds each represented by following Formula (6):

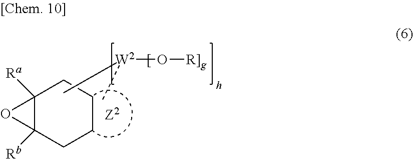

wherein Ring Z² represents a nonaromatic carbocyclic ring and may be present or absent in the molecule; R represents a substituted or unsubstituted vinyl group represented by Formula (4); W² is a linkage group connecting between the substituted or unsubstituted vinyloxy group (—OR group) and the cyclohexane ring or Ring Z and represents a single bond or an organic group having a valency of (g+1); R^{a} and R^{b} are the same as or different from each other and each represent a hydrogen atom or an alkyl group; “g” and “h” are as defined above, and “g” and “h” each independently denote 1 or 2, wherein, when “g” and/or “h” is 2, two substituents in the brackets may be the same as or different from each other.

When R^{a} and R^{b} are both hydrogen atoms in the compounds, it is preferred that at least Ring Z² is present, or W² is a group represented by following Formula (7):

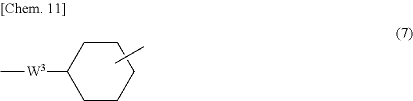

wherein W³ represents a single bond or a divalent organic group, wherein a carbon atom constituting the cyclohexane ring is bonded to the —OR group.

The compounds having this configuration are vinyl ether compounds each containing an alicyclic epoxy group (group composed of 1,2-epoxycyclohexane ring, i.e., 7-oxabicyclo[4.1.0]heptane ring) and further having a nonaromatic carbocyclic ring at a specific position in the molecule or having an alkyl group at a junction site between the oxirane ring and the cyclohexane ring constituting the alicyclic epoxy group. Such vinyl ether compounds not only are curable extremely rapidly but give, through curing, cured products excellent in properties such as optical transparency and thermal stability, thus being significantly advantageous.

In Formula (6), Ring Z² represents a nonaromatic carbocyclic ring. Ring Z² may be present or absent in the molecule. Exemplary nonaromatic carbocyclic rings include those listed as the nonaromatic carbocyclic ring in the oxetane-ring-containing vinyl ether compound (A).

In Formula (6), R represents a substituted or unsubstituted vinyl group represented by Formula (4). In Formula (4), R¹⁴, R¹⁵ and R¹⁶ are the same as or different from one another and each represent a hydrogen atom or an alkyl group having 1 to 4 carbon atoms. Exemplary alkyl groups each having 1 to 4 carbon atoms include those listed as the alkyl group having 1 to 4 carbon atoms in the oxetane-ring-containing vinyl ether compound (A).

In Formula (6), W² is a linkage group connecting between the substituted or unsubstituted vinyloxy group (—OR group) and the cyclohexane ring or Ring Z and represents a single bond or an organic group having a valency of (m+1). The organic group is generally a group having a carbon atom at the bonding site to the adjacent oxygen atom. Preferred examples of the organic group include (i) hydrocarbon groups and (ii) groups each composed of one or more hydrocarbon groups and at least one group selected from the group consisting of oxygen atom (—O—), sulfur atom (—S—), carbonyl group (—CO—), and amino group (—NH—).

The hydrocarbon groups include aliphatic hydrocarbon groups, alicyclic hydrocarbon groups, aromatic hydrocarbon groups, and hydrocarbon groups each composed of two or more of these bonded to each other.

Examples of the hydrocarbon groups include those listed in the oxetane-ring-containing vinyl ether compound (A). Such hydrocarbon groups may be substituted with one or more substituents. Exemplary substituents include those listed in the oxetane-ring-containing vinyl ether compound (A).

Preferred examples of W² include those listed in the oxetane-ring-containing vinyl ether compound (A). Above all, W is preferably a single bond, or a linear or branched chain alkylene groups each having 1 to 6 carbon atoms, or a group composed of the alkylene group and at least one group selected from the group consisting of oxygen atom (—O—), sulfur atom (—S—), and carbonyl group (—CO—) bonded to each other.

The bonding position of W² to the cyclohexane ring or Ring Z² is not critical. However, when Ring Z is absent, W² is preferably bonded to the cyclohexane ring at the 4-position and/or 5-position, provided that the junction positions with the oxirane ring are the 1-position and 2-position.

In Formula (6), R^{a} and R^{b} are the same as or different from each other and each represent a hydrogen atom or an alkyl group. Exemplary alkyl groups include linear or branched chain alkyl groups each having 1 to about 15 carbon atoms, such as methyl, ethyl, propyl, isopropyl, butyl, isobutyl, s-butyl, t-butyl, hexyl, octyl, and decyl groups. Of these, alkyl groups each having 1 to 6 carbon atoms are preferred, of which alkyl groups each having 1 to 3 carbon atoms, such as methyl group, are more preferred.

In Formula (6), “f” represents 1 or 2 and is preferably 1; and “h” represents 1 or 2. When “g” and/or “h” is 2, two substituents in the brackets may be the same as or different from each other. When R^{a} and R^{b} are both hydrogen atoms, it is preferred that at least Ring Z² is present in the molecule or W² is a group represented by Formula (7).

In Formula (7), W³ represents a single bond or a divalent organic group. Exemplary divalent organic groups include divalent hydrocarbon groups; and groups each composed of a divalent hydrocarbon group and at least one group selected from the group consisting of oxygen atom (—O—), sulfur atom (—S—), carbonyl group (—CO—), and amino group (—NH—) bonded to each other. Exemplary divalent hydrocarbon groups include those mentioned above. Above all, W³ is preferably a single bond or an alkyleneoxy group having 1 to 6 carbon atoms (whose oxygen atom being in the rightmost portion).

Of the compounds represented by Formula (6), preferred are compounds represented by following Formula (6a), (6b) or (6c):

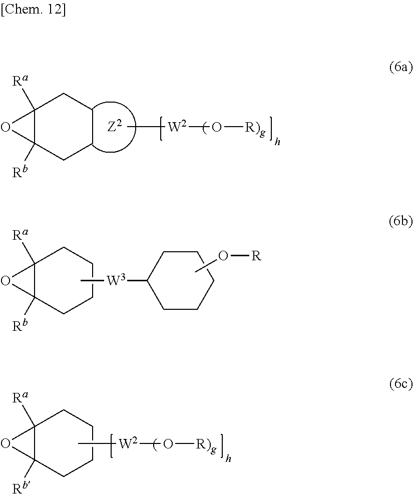

wherein R^{b′} represents an alkyl group having 1 to 6 carbon atoms; and Ring Z², R, R^{a}, R^{b}, W², W³, “g”, and “h” are as defined above, and wherein W² in Formula (6a) connects between —OR group and Ring Z².

In Formula (6a), R^{a} and R^{b} are each preferably a hydrogen atom or an alkyl group having 1 to 6 carbon atoms and are each more preferably a hydrogen atom or an alkyl group having 1 to 3 carbon atoms (e.g., methyl group). It is also preferred that at least one of R^{a} and R^{b} is a hydrogen atom. Ring Z is particularly preferably a cycloalkane ring having about 5 to about 12 members, such as cyclopentane ring, cyclohexane ring, or cyclooctane ring; or a bridged alicyclic ring having about 8 to about 15 carbon atoms, such as decalin ring or norbornane ring. W is preferably a single bond; a hydrocarbon group having 1 to 15 carbon atoms; or a group composed of one or more hydrocarbon groups each having 1 to 15 carbon atoms and at least one group selected from oxygen atom (—O—), sulfur atom (—S—), carbonyl group (—CO—), and amino group (—NH—) bonded to each other.

In Formula (6b), R^{a} and R^{b} are each preferably a hydrogen atom or an alkyl group having 1 to 6 carbon atoms and are each more preferably a hydrogen atom or an alkyl group having 1 to 3 carbon atoms (e.g., methyl group). It is also preferred that at least one of R^{a} and R^{b} is a hydrogen atom. W¹ is preferably a single bond or an alkyleneoxy group having 1 to 6 carbon atoms (whose oxygen atom being in the rightmost portion).

In Formula (6c), R^{a} is preferably a hydrogen atom or an alkyl group having 1 to 6 carbon atoms, more preferably a hydrogen atom or an alkyl group having 1 to 3 carbon atoms, and particularly preferably a hydrogen atom. R^{b′} is preferably an alkyl group having 1 to 3 carbon atoms and particularly preferably methyl group. W is particularly preferably a single bond, a hydrocarbon group having 1 to 15 carbon atoms, or a group composed of one or more hydrocarbon groups each having 1 to 15 carbon atoms and at least one group selected from oxygen atom (—O—), sulfur atom (—S—), carbonyl group (—CO—), and amino group (—NH—) bonded to each other.

Representative examples of the alicyclic-epoxy-group-containing vinyl ether compound (B) for use herein include compounds as follows. In the following formulae, “p” and “q” each denote 0 or 1; and A³ represents a linear or branched chain alkylene group having 2 to 10 carbon atoms (preferably 2 to 6 carbon atoms).

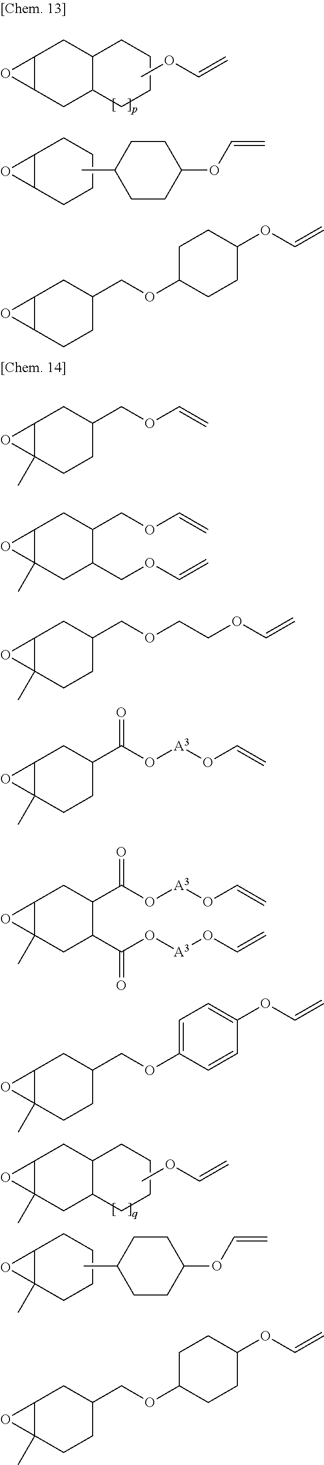

The alicyclic-epoxy-group-containing vinyl ether compound (B) for use herein may be prepared by using a reaction known as a production process of vinyl ether compounds. In a preferred embodiment, the alicyclic-epoxy-group-containing vinyl ether compound (B) is prepared by a process of reacting an alcohol (hydroxy compound), corresponding to the alicyclic-epoxy-group-containing vinyl ether compound (B), with a vinyl ester compound in the presence of a transition element compound. Specifically, an alicyclic-epoxy-group-containing vinyl ether compound (B) represented by Formula (6) may be prepared by reacting a corresponding alcohol (hydroxy compound), wherein R in Formula (6) is a hydrogen atom, with a vinyl ester compound in the presence of a transition element compound. The alcohol (hydroxy compound) corresponding to the alicyclic-epoxy-group-containing vinyl ether compound (B) may be synthetically prepared from a known compound using a known reaction.

[Oligomer or Polymer (C)]

The oligomer or polymer (C) for use in the present invention has, in the molecule, at least one selected from the group consisting of oxetane group, epoxy group, hydroxyl group, vinyl ether group, and an aliphatic or alicyclic unsaturated hydrocarbon group and has a molecular weight of 500 or more (specifically, has a molecular weight of from 500 to 10×10⁴ and preferably from 3000 to 3×10⁴).

The oligomer or polymer (C) for use herein is preferably an oligomer or polymer having a structure of Formulae (1a), (1b), (1c), and (1d) in combination, containing a terminal hydroxyl group or a terminal hydrogen atom, and having a molecular weight of 500 or more; or an oligomer or polymer being represented by Formula (1e), containing a terminal hydroxyl group or a terminal hydrogen atom, and having a molecular weight of 500 or more.

The oligomer or polymer (C), if having a molecular weight of less than 500, may impede the formation of a cured product with sufficient flexibility from the cationically polymerizable resin composition. In contrast, the oligomer or polymer (C), if having a molecular weight of more than 10×10⁴, may have an excessively high viscosity and may be difficult to handle, thus being undesirable.

In Formulae (1a) to (1d), the substituted or unsubstituted hydrocarbon groups each having 1 to 20 carbon atoms as R¹ to R¹² include aliphatic hydrocarbon groups, alicyclic hydrocarbon groups, aromatic hydrocarbon groups, and groups each composed of two or more of these bonded to each other. Exemplary aliphatic hydrocarbon groups include alkyl groups each having 1 to about 20 carbon atoms, such as methyl, ethyl, propyl, isopropyl, butyl, isobutyl, s-butyl, t-butyl, pentyl, hexyl, decyl, and dodecyl groups, of which those each having 1 to 10 carbon atoms are preferred, and those each having 1 to about 3 carbon atoms are more preferred; alkenyl groups each having 2 to about 20 carbon atoms, such as vinyl, allyl, and 1-butenyl groups, of which those each having 2 to about 10 carbon atoms are preferred, and those each having approximately 2 or 3 carbon atoms are more preferred; and alkynyl groups each having 2 to about 20 carbon atoms, such as ethynyl and propynyl groups, of which those each having 2 to about 10 carbon atoms are preferred, and those each having approximately 2 or 3 carbon atoms are more preferred.

Exemplary alicyclic hydrocarbon groups include cycloalkyl groups each having 3 to about 20 members, such as cyclopropyl, cyclobutyl, cyclopentyl, cyclohexyl, and cyclooctyl groups, of which those each having 3 to about 15 members are preferred, and those each having about 5 to about 8 members are more preferred; cycloalkenyl groups each having 3 to about 20 members, such as cyclopentenyl and cyclohexenyl groups, of which those each having 3 to about 15 members are preferred, and those each having about 5 to about 8 members are more preferred; and bridged hydrocarbon groups such as perhydronaphth-1-yl group, norbornyl, adamantyl, and tetracyclo[4.4.0.1^{2,5}.1^{7,10}]dodec-3-yl groups. Exemplary aromatic hydrocarbon groups include aromatic hydrocarbon groups each having about 6 to about 14 carbon atoms, such as phenyl and naphthyl groups, of which those each having about 6 to about 10 carbon atoms are preferred.

Exemplary hydrocarbon groups each composed of an aliphatic hydrocarbon group and an alicyclic hydrocarbon group bonded to each other include cycloalkyl-alkyl groups such as cyclopentylmethyl, cyclohexylmethyl, and 2-cyclohexylethyl groups, of which cycloalkyl-alkyl groups whose cycloalkyl moiety having 3 to 20 carbon atoms and whose alkyl moiety having 1 to 4 carbon atoms are preferred. Exemplary hydrocarbon groups each composed of an aliphatic hydrocarbon group and an aromatic hydrocarbon group bonded to each other include aralkyl groups such as aralkyl groups each having 7 to 18 carbon atoms; and alkyl-substituted aryl groups such as phenyl group or naphthyl group substituted with one to about four alkyl groups each having 1 to 4 carbon atoms.

Preferred examples of such hydrocarbon groups include alkyl groups each having 1 to 10 carbon atoms, alkenyl groups each having 2 to 10 carbon atoms, alkynyl groups each having 2 to 10 carbon atoms, cycloalkyl groups each having 3 to 15 carbon atoms, aromatic hydrocarbon groups each having 6 to 10 carbon atoms, cycloalkyl-alkyl groups whose cycloalkyl moiety having 3 to 15 carbon atoms and whose alkyl moiety having 1 to 4 carbon atoms, and aralkyl groups each having 7 to 14 carbon atoms.

The hydrocarbon groups may each have one or more substituents. Exemplary substituents include halogen atoms, oxo group, hydroxyl group, substituted oxy groups (e.g., alkoxy groups, aryloxy groups, aralkyloxy groups, and acyloxy groups), carboxyl group, substituted oxycarbonyl groups (e.g., alkoxycarbonyl groups, aryloxycarbonyl groups, and aralkyloxycarbonyl groups), substituted or unsubstituted carbamoyl groups, cyano group, nitro group, substituted or unsubstituted amino groups, sulfo group, and heterocyclic groups. The hydroxyl group and the carboxyl group may each be protected by a protecting group customarily used in organic syntheses. To each ring of the alicyclic hydrocarbon groups and aromatic hydrocarbon groups, an aromatic or nonaromatic heterocyclic ring may be fused.

In Formula (1e), examples of the substituted or unsubstituted divalent hydrocarbon group as R¹³, and examples of substituents which the hydrocarbon group may have include those listed as the divalent hydrocarbon group as W in Formula (2), and those listed as substituents which the hydrocarbon groups may have.

As the oligomer or polymer (C) for use herein, preferred are polycarbonate polyols represented by following Formula (8) [of which polycarbonate polyols represented by following Formula (9) are more preferred], or cationically polymerizable resin compositions each having at least an epoxy group and an aliphatic or alicyclic unsaturated hydrocarbon group [of which epoxidized polybutadienes each represented by following Formula (10) and having hydroxyl groups at both terminals are more preferred].

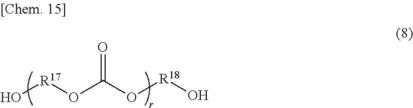

wherein “r” denotes an integer of 10 or more; and R¹⁷ and R¹⁸ may be the same as or different from each other and each represent a hydrogen atom or an alkyl group having 1 to 4 carbon atoms;

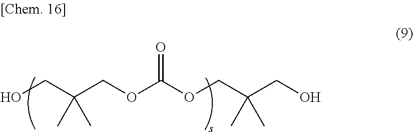

wherein “s” denotes an integer of 10 or more;

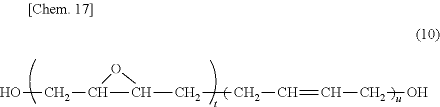

wherein “t” denotes the repetition number of a constitutional repeating unit composed of 2,3-epoxy-1,4-tetramethylene group; “u” denotes the repetition number of a constitutional repeating unit composed of 2-butenylene group, and wherein the 2,3-epoxy-1,4-tetramethylene group and 2-butenylene group may undergo random polymerization or block polymerization. In epoxidized polybutadienes each represented by Formula (10) and having hydroxyl groups at both terminals, the repetition number of constitutional repeating units is indicated by (t+u), wherein “t” and “u” each denote an integer of 1 or more; and (t+u) denote an integer of 10 or more.

Preferred examples for use herein as the oligomer or polymer (C) include commercial products under the trade name “PB3600” (supplied by Daicel Chemical Industries, Ltd.) and the trade name “CD220PL” (supplied by Daicel Chemical Industries, Ltd.), of which the product under the trade name “PB3600” (supplied by Daicel Chemical Industries, Ltd.) is more preferred.

[Oxetane Compound (D) Containing No Vinyl Ether Group and Having 6 or More Carbon Atoms]

The oxetane compound (D) containing no vinyl ether group and having 6 or more carbon atoms for use in the present invention is not limited, as long as being a compound having an oxetane ring, having 6 or more carbon atoms (e.g., 6 to 30 carbon atoms, and preferably 7 to 25 carbon atoms), and containing no vinyl ether group. The presence of the oxetane compound (D) in the cationically polymerizable resin composition significantly improves the post-heating bendability (flexibility) without impairing other properties.

Representative examples of the oxetane compound (D) containing no vinyl ether group and having 6 or more carbon atoms include compounds each represented by Formula (2).

In Formula (2), R^{a} represents a hydrocarbon group; and R^{b} represents a hydrocarbon group other than a vinyl group. Exemplary hydrocarbon groups as R^{a} and R^{b} include aliphatic hydrocarbon groups, alicyclic hydrocarbon groups, aromatic hydrocarbon groups, and groups each composed of two or more of these bonded to each other.

Exemplary aliphatic hydrocarbon groups include alkyl groups each having 1 to 20 carbon atoms, such as methyl, ethyl, propyl, isopropyl, butyl, isobutyl, s-butyl, t-butyl, pentyl, hexyl, heptyl, octyl, isooctyl, 2-ethylhexyl, decyl, dodecyl, and tetradecyl groups, of which those each having 1 to 12 carbon atoms are preferred; alkenyl groups each having 2 to 20 carbon atoms, such as vinyl, allyl, 1-butenyl, 2-butenyl, and 1-hexenyl groups, of which those having 2 to 12 carbon atoms are preferred; and alkynyl groups each having 2 to 20 carbon atoms, such as ethynyl and propynyl groups, of which those having 2 to 12 carbon atoms are preferred. Exemplary alicyclic hydrocarbon groups include cycloalkyl groups each having 3 to about 20 members, such as cyclopentyl, cyclohexyl, and cyclooctyl groups, of which those each having 3 to about 15 members are preferred, and those each having about 5 to about 8 members are more preferred; cycloalkenyl groups each having 3 to about 20 members, such as cyclopentenyl and cyclohexenyl groups, of which those each having 3 to about 15 members are preferred, and those each having about 5 to about 8 members are more preferred; and bridged hydrocarbon groups such as perhydronaphth-1-yl group, norbornyl, adamantyl, and tetracyclo[4.4.0.1^{2,5}.1^{7,10}]dodec-3-yl groups. Exemplary aromatic hydrocarbon groups include aromatic hydrocarbon groups each having about 6 to about 14 carbon atoms, such as phenyl and naphthyl groups, of which those having about 6 to about 10 carbon atoms are preferred. Exemplary hydrocarbon groups each composed of an aliphatic hydrocarbon group and an alicyclic hydrocarbon group bonded to each other include cycloalkyl-alkyl groups such as cyclopentylmethyl, cyclohexylmethyl, and 2-cyclohexylethyl groups, of which cycloalkyl-alkyl groups whose cycloalkyl moiety having 3 to 20 carbon atoms and whose alkyl moiety having 1 to 4 carbon atoms are preferred. Exemplary hydrocarbon groups each composed of an aliphatic hydrocarbon group and an aromatic hydrocarbon group bonded to each other include aralkyl groups such as benzyl group, of which aralkyl groups each having 7 to 18 carbon atoms are preferred; alkyl-substituted aryl groups such as tolyl group, of which phenyl group or naphthyl group substituted with one to about four alkyl groups each having 1 to 4 carbon atoms are preferred. Of these, preferred are alkyl groups each having 1 to about 20 carbon atoms, of which those each having 1 to 12 carbon atoms are more preferred; alicyclic hydrocarbon groups each having 3 to 20 members, of which those each having 3 to 15 members are more preferred; and groups each composed of two or more of these bonded to each other.

Each of the hydrocarbon groups may have one or more halogen atoms as substituents.

Specific examples of the oxetane compound (D) containing no vinyl ether group and having 6 or more carbon atoms include 3-ethyl-3-(2-ethylhexyloxymethyl)oxetane represented by following Formula (2a), and 3-ethyl-3-(cyclohexyloxymethyl)oxetane represented by following Formula (2b):

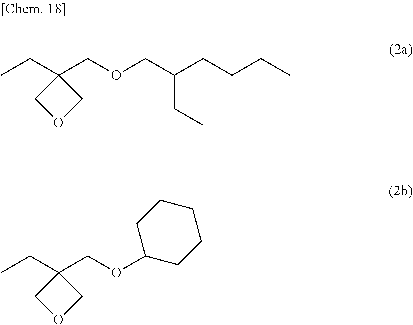

[Cationically Polymerizable Resin Composition]

Cationically polymerizable resin compositions according to embodiments of the present invention each contain the oxetane-ring-containing vinyl ether compound (A) and/or the alicyclic-epoxy-group-containing vinyl ether compound (B); the oligomer or polymer (C) containing at least one selected from the group consisting of oxetane group, epoxy group, hydroxyl group, vinyl ether group, and an aliphatic or alicyclic unsaturated hydrocarbon group in the molecule and having a molecular weight of 500 or more; and the oxetane compound (D) containing no vinyl ether group and having 6 or more carbon atoms.

A cationically polymerizable resin composition according to the present invention contains the oxetane-ring-containing vinyl ether compound (A) and/or the alicyclic-epoxy-group-containing vinyl ether compound (B) in a content (total content) of preferably from 6 to 80 percent by weight, and more preferably from 20 to 65 percent by weight, based on the total weight of the cationically polymerizable resin composition. The cationically polymerizable resin composition, if containing one or both of these components in a content (total content) of less than 6 percent by weight, may be cured significantly slowly, thus being unpractical. In contrast, the cationically polymerizable resin composition, if containing one or both of these components in a content (total content) of more than 80 percent by weight, may be difficult to give a cured product having sufficient flexibility. In an embodiment, the cationically polymerizable resin composition employs the oxetane-ring-containing vinyl ether compound (A) and/or alicyclic-epoxy-group-containing vinyl ether compound (B) in a content within the above range and thereby gives a cured product having both excellent curability and sufficient flexibility. The cationically polymerizable resin composition is very advantageous as materials in fields requiring satisfactory thermal stability, optical transparency, flexibility, and curability, and particularly in optical uses such as optical waveguides. The thermal stability is evaluated herein by rate of weight loss on heating and post-heating optical loss.

The cationically polymerizable resin composition contains the oligomer or polymer (C) in a content of preferably from 5 to 90 percent by weight, and more preferably from 10 to 65 percent by weight, based on the total weight of the cationically polymerizable resin composition. The cationically polymerizable resin composition, if containing the oligomer or polymer (C) in a content of less than 5 percent by weight, may give a cured product having insufficient flexibility through curing, and this may impede the use of the cured product typically as a flexible optical waveguide. In contrast, the cationically polymerizable resin composition, if containing the oligomer or polymer (C) in a content of more than 90 percent by weight, may have an excessively high viscosity and may thereby be difficult to use.

The cationically polymerizable resin composition contains the oxetane compound (D) containing no vinyl ether group and having 6 or more carbon atoms in a content of preferably from 4 to 85 percent by weight, and more preferably from 10 to 70 percent by weight, based on the total weight of the cationically polymerizable resin composition. The cationically polymerizable resin composition, if containing the oxetane compound (D) containing no vinyl ether group and having 6 or more carbon atoms in a content of less than 4 percent by weight, may give, through curing, a cured product with insufficient post-heating bendability (flexibility), and this may impede the use of the cured product typically as a flexible optical waveguide. In contrast, the cationically polymerizable resin composition, if containing the oxetane compound (D) containing no vinyl ether group and having 6 or more carbon atoms in a content of more than 85 percent by weight, may be cured slowly and may often give a cured product which is fragile.

The cationically polymerizable resin composition may further contain other additives according to necessity. Typically, the cationically polymerizable resin composition may further contain one or more polymerization initiators. The polymerization initiators are not limited, as long as being photo-induced cationic polymerization initiators and other initiators capable of initiating ionic (cationic) polymerization, and may be any of, for example, known polymerization initiators and light-activatable acid generators.

The photo-induced cationic polymerization initiators are preferably composed of a cationic moiety and an anionic moiety, in which the anionic moiety has a charge density equal to or higher than that of PFC. This is because such photo-induced cationic polymerization initiators are extremely satisfactorily soluble, exhibit excellent cationic curability to improve the curing rate significantly, and give cured products with very excellent optical transparency. A photo-induced cationic polymerization initiator, if being composed of an anionic moiety having a charge density lower than that of PF₆⁻, may show insufficient coloring resistance, thus being unsuitable in applications where optical transparency is required, though the photo-induced cationic polymerization initiator exhibits higher reactivity and solubility. As used herein the term “charge density” is used in the meaning defined by J. V. Crivello and J. H. W. Lam in Macromolecules, 1307, Vol. 10, 1997. The anionic moiety “having a charge density equal to or higher than that of PF₆⁻” may be any of anions containing at least one fluorine atom and having high nucleophilicity, such as PF₆⁻, BF₄⁻, and CF₃SO₄⁻.

Exemplary photo-induced polymerization initiators for use herein include sulfonium salts such as triallylsulfonium hexafluorophosphate and triarylsulfonium hexafluoroantimonates; iodonium salts such as diaryliodonium hexafluorophosphates, diphenyllodonium hexafluoroantimonate, bis(dodecylphenyl)iodonium tetrakis(pentafluorophenyl)borate, and iodonium [4-(4-methylphenyl-2-methylpropyl)phenyl]hexafluorophosphate; phosphonium salts such as tetrafluorophosphonium hexafluorophosphate; and Pyridium salts. Such polymerization initiators are readily soluble in the oxetane-ring-containing vinyl ether compound (A) and/or alicyclic-epoxy-group-containing vinyl ether compound (B), from which the polymerizable composition is easily prepared.

Such photo-induced cationic polymerization initiators may be commercially available as products typically under the trade names “Irgacure 250” from Ciba Japan (now part of BASF Japan Ltd.) and “Uvacure 1591” from Daicel-Cytec Co., Ltd.

The cationically polymerizable resin composition contains polymerization initiators in an amount of generally from about 0.01 to about 50 percent by weight, and preferably from about 0.1 to about 20 percent by weight, based on the total weight of the cationically polymerizable resin composition. The cationically polymerizable resin composition, when containing polymerization initiators in an amount within the above range, may be a cationically polymerizable resin composition excellent in balance between polymerization rate and storage stability.

Where necessary, the cationically polymerizable resin composition may further contain one or more curable compounds (e.g., epoxy compounds, oxetane compounds, and vinyl ether compounds) other than the oxetane-ring-containing vinyl ether compound (A) and/or alicyclic-epoxy-group-containing vinyl ether compound (B), and oxetane compound (D) containing no vinyl ether group and having 6 or more carbon atoms. Typically, the cationically polymerizable resin composition may further contain a product under the trade name “CELLOXIDE 2021P” (supplied by Daicel Chemical Industries, Ltd.). The product under the trade name “CELLOXIDE 2021P” (supplied by Daicel Chemical Industries, Ltd.) may easily form a bonding with an adherend and, when used in an amount of 1 to 30 percent by weight in the cationically polymerizable resin composition, helps the cationically polymerizable resin composition to give a cured product with higher adhesion to the adherend.

The cationically polymerizable resin composition may further contain known additives according to necessity. Exemplary additives herein include setting-expandable monomers (e.g., spiroorthocarbonates and dithiocarbonates), photosensitizers (e.g., anthracene sensitizers), resins, adhesion promoters, reinforcers, softeners, plasticizers, viscosity modifiers, solvents, inorganic or organic particles (e.g., nano-scale particles), and fluorosilanes.

The setting-expandable monomers, when added, help the cationically polymerizable resin composition to show a lower cure shrinkage and are thereby expected to contribute typically to a lower residual stress and higher adhesion effectively. Exemplary setting-expandable monomers include bicycloepoxy compounds each represented by following Formula (11):

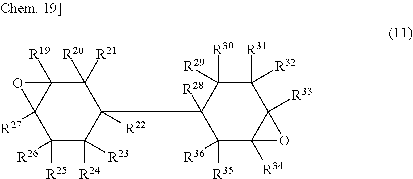

wherein R¹⁹, R²⁰, R²¹, R²², R²³, R²⁴, R²⁵, R²⁶, R²⁷, R²⁸, R²⁹, R³⁰, R³¹, R³², R³³, R³⁴, R³⁵, and R³⁶ each independently represent a hydrogen atom, a halogen atom, a hydrocarbon group which may have an oxygen atom or a halogen atom, or a substituted or unsubstituted alkoxy group,
and carbonate compounds each represented by following Formula (12):

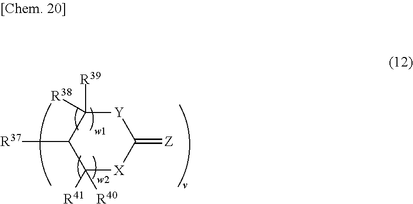

wherein R³⁷, R³⁸, R³⁹, R⁴⁰, and R⁴¹ each independently represent a hydrogen atom, a halogen atom, a hydrocarbon which may have an oxygen atom or a halogen atom, or a substituted or unsubstituted alkoxy group; “v” denotes an integer of 1 to 6; w1 and w2 each denote an integer of 0 to 3; and X, Y, and Z each represent an oxygen atom or a sulfur atom.

The photosensitizers help the photo-induced cationic polymerization initiators to exhibit higher actions and promote the cationically polymerizable resin composition to undergo a photo-induced cationic polymerization more satisfactorily. Examples of such photosensitizers usable herein include, but are not limited to, carbonyl compounds, organic sulfur compounds, persulfides, redox compounds, azo compounds, diazo compounds, halogen compounds, and photoreductive dyes. Specific examples of photosensitizers include benzoin derivatives such as benzoin methyl ether and benzoin isopropyl ether; benzophenone derivatives such as benzophenone, 2,4-dichlorobenzophenone, methyl o-benzoylbenzoate, and 4,4′-bis(dimethylamino)benzophenone; thioxanthone derivatives such as 2-chlorothioxanthone and 2-isopropylthioxanthone; anthraquinone derivatives such as 2-chloroanthraquinone and 2-methylanthraquinone; and anthracene derivatives such as dipropoxyanthracene and dibutoxyanthracene. Each of different photosensitizers may be used alone or in combination.

The cationically polymerizable resin composition may be prepared by mixing and blending the oxetane-ring-containing vinyl ether compound (A) and/or alicyclic-epoxy-group-containing vinyl ether compound (B), oligomer or polymer (C), oxetane compound (D) containing no vinyl ether group and having 6 or more carbon atoms, and additives according to necessity using a customarily known device. The preparation of the cationically polymerizable resin composition is preferably performed while blocking ultraviolet rays, and the prepared cationically polymerizable resin composition is preferably placed in a light-tight enclosure and stored in a cool, dark place before use.

Cationically polymerizable resin compositions according to the present invention each contain the oxetane-ring-containing vinyl ether compound (A) and/or alicyclic-epoxy-group-containing vinyl ether compound (B), oligomer or polymer (C), and oxetane compound (D) containing no vinyl ether group and having 6 or more carbon atoms. Accordingly, they have a low viscosity, are easy to work, and are cured extremely rapidly (have a very high curing rate). In addition, they give, through curing, cured products which excel in optical transparency, thermal stability, flexibility, and post-heating bendability (flexibility). For these reasons, the cationically polymerizable resin compositions are usable in a wide variety of fields such as paints, coating materials, ink-jet inks and other inks, adhesives, resists, plate-making materials, molding materials, color filters, flexible boards, encapsulants (sealing materials), as well as optical fields such as waveguides (e.g., optical waveguides and hybrid substrates), and optical fibers. Above all, the cationically polymerizable resin compositions are extremely useful in flexible optical waveguides and other optical uses. In addition, they are advantageously usable as resin compositions for optically transparent sealants and for nanoimprinting technologies.

[Cured Products]

A cured product according to the present invention may be obtained by applying light to and thereby polymerizing a cationically polymerizable resin composition according to the present invention. Typically, the cured product may be obtained by forming a desired image or shape using the cationically polymerizable resin composition according to a customary procedure such as ink-jet technique or lithography and exposing the formed image or shape to light.

The exposure may be performed using an irradiation source such as a mercury lamp, xenon lamp, carbon arc lamp, metal halide lamp, sun-light, electron beams, or laser beams. The curing may be controlled by suitably setting conditions such as intensity of light to be applied, temperature, and irradiation time; and/or by selecting the components (e.g., addition of curing control agents) of the cationically polymerizable resin composition. Above all, the curing is preferably controlled by temperature control during exposure and after exposure (postbaking).

After the exposure, the cationically polymerizable resin composition may be subjected to a heat treatment at a temperature typically of from about 50° C. to 180° C. to promote the curing. Such a heat treatment after exposure (postbaking) is effective for curing of a thick film or curing of unexposed portions, or curing of a cationically polymerizable resin composition containing, for example, fillers or pigments.

Cured products according to the present invention excel typically in optical transparency, thermal stability, flexibility, and post-heating bendability (flexibility). They are therefore extremely useful in the fields of waveguides (e.g., optical waveguides and opto-electric hybrid circuit boards), optical fibers, optically transparent sealants, ink-jet inks, color filters, nanoimprinting technologies, and flexible boards. Above all, they are extremely useful in the fields of flexible optical waveguides, optically transparent sealants, and nanoimprinting technologies.

The optical transparency herein may be evaluated by transmittance of light at a wavelength of from 400 to 850 nm. The present invention may give cured products having the transmittance of typically 70% or more, preferably 80% or more, and particularly preferably 85% or more and having satisfactory optical transparency.

The flexibility herein may be evaluated by bendability. Typically, the bendability may be determined by placing a film-shaped cured product having a thickness of 200 μm around a rod having a radius of 2 mm, and observing whether or not cracking occurs. The present invention may give cured products which have such satisfactory flexibility as to bend without cracking.

The thermal stability as used herein means that a cured product obtained from a cationically polymerizable resin composition by light irradiation maintains its weight even when subjected to a heat treatment. Cured products of the cationically polymerizable resin compositions according to the present invention have satisfactory thermal stability and are very useful in fields where the cured products are exposed to heat after curing.

The post-heating bendability (flexibility) may be evaluated by the procedure for the evaluation of flexibility as above, except that a sample cured product is subjected to a heat treatment before evaluation.

[Optical Waveguides]

An optical waveguide is an optical circuit composed of a core having a high refractive index and a clad having a low refractive index. Cationically polymerizable resin compositions according to the present invention each have a low viscosity, are easy to work, are extremely rapidly cured, and give cured products with high productivity. In addition, the obtained cured products are flexible and have such thermal stability as to enable soldering and other workings. Furthermore, cured products of the cationically polymerizable resin compositions maintain satisfactory optical transparency not only immediately after curing but also after heating and exhibit such excellent optical properties as to extremely suppress optical loss. The cationically polymerizable resin compositions are very useful as materials for constituting the clad and core of an optical waveguide. For example, when a cationically polymerizable resin composition according to the present invention is used as a material for the formation of the clad, a material for the formation of the core may be a material containing the cationically polymerizable resin composition and further containing a material having a high refractive index (e.g., 1-acryloxy-4-methoxynaphthalene). Vice versa, when a cationically polymerizable resin composition according to the present invention is used as a material for the formation of the core, a material for the formation of the clad may be a material containing the cationically polymerizable resin composition and further containing a material having a low refractive index.

An optical waveguide according to the present invention may be prepared typically by applying a cationically polymerizable resin composition according to the present invention to a film to form a clad base film; and covering a core with the clad base film.

More specifically but illustratively, the optical waveguide may be produced typically by a reactive ion etching (RIE) process of applying the cationically polymerizable resin composition to a substrate (film) to form a clad layer, laminating a core layer on the clad layer, further applying a resist to form a resist film thereon, exposing the resist film through a mask, followed by developing, etching, and removing the resist to form a core, and forming an upper clad layer so as to cover the core.

A cationically polymerizable resin composition, when used for optical waveguides, may further contain, for example, a metal oxide of nanometer size, in order to regulate the refractive index. Exemplary metal oxides include zirconium oxide and titanium oxide, and such metal oxides may have a size of typically from about 1 to about 100 nm. The cationically polymerizable resin composition preferably further contain one or more setting-expandable compounds such as bicyclohexene oxide and/or 2,2-dimethylpropyl carbonate, for the purpose of suppressing cure shrinkage.

Suitability as an optical waveguide may be determined through known evaluations for waveguide properties. Though not limited, such waveguide properties may be evaluated typically by a method of measuring an optical loss according to a known procedure on a simplified waveguide composed of a cured product of the cationically polymerizable resin composition. Cured products of the cationically polymerizable resin compositions according to the present invention each have an optical loss of 0.3 dB/cm or less, and preferably 0.2 dB/cm or less as determined by a cutback technique at a wavelength of 850 nm and have satisfactory optical waveguide properties. Optical waveguides formed using the cured products of the cationically polymerizable resin compositions have good thermal stability and are significantly resistant to increase in optical loss even after heating.

Optical waveguides according to the present invention are formed from the cationically polymerizable resin compositions according to the present invention, thereby have satisfactory flexibility, are capable of bending freely, and, even when they are bent, do not suffer from cracking and from increase in optical loss. The optical waveguides are therefore usable as being suitably deformed according to the shapes of positions where the optical waveguides are arranged. They are highly thermally stable, can thereby undergo soldering or another working, are resistant to increase in optical loss even after heating, and are thereby usable even in high-temperature surroundings. In addition, they are highly optically transparent and do not suffer from deterioration in optical transparency even after heating.

The optical waveguides may be usable as optical circuit boards independently or may be hybridized with an electric wiring. In this case, the optical waveguides may be used as optical interconnections for opto-electric hybrid circuits.

[Opto-Electric Hybrid Circuit Boards]

An opto-electric hybrid circuit board (wiring board) according to an embodiment of the present invention includes the optical waveguide, and an electric wiring present on or above at least one surface of the optical waveguide. The optical waveguide according to the present invention is highly thermally stable and, when hybridized into a printed circuit board including an electric wiring, can be handled as is conventionally done. The optical waveguide is also highly flexible and can be hybridized with a flexible printed circuit board (FPC).

The electric wiring may be formed typically through plating, printing, or etching. The plating (e.g., nickel, copper, or silver plating) may be conducted according to a known procedure such as electroless plating or electrolytic plating. The printing may be conducted generally typically by performing screen-process printing or ink-jet printing with an electroconductive ink containing electroconductive particles. Exemplary electroconductive particles include electroconductive inorganic particles such as particles of silver, gold, copper, nickel, ITO, and carbon, as well as carbon nanotubes; and electroconductive organic polymer particles such as particles of polyanilines, polythiophenes, polyacetylenes, and polypyrroles. The etching may be conducted typically by affixing a copper foil to the surface of the substrate and removing unnecessary portions of the copper foil through etching.

An opto-electric hybrid circuit board according to another embodiment of the present invention may include the optical waveguide, an electric wiring, and a porous layer present between the optical waveguide and the electric wiring. The opto-electric hybrid circuit board according to this embodiment may have a further finer wiring (further finer interconnections).

The porous layer present on a surface of the optical waveguide has a thickness of typically from 0.1 to 100 μm, preferably from 0.5 to 70 μm, and more preferably from 1 to 50 μm. The porous layer includes a multiplicity of continuous micropores. The micropores preferably has an average pore size (i.e., average size of micropores inside the film) of from 0.01 to 10 μm, and more preferably from 0.05 to 5 μm. The micropores, if having an average pore size out of the above range, may be difficult to exhibit desired effects according to the intended use and thereby be inferior in pore properties. Typically, the micropores, if having an excessively small size, may cause the porous layer to have insufficient cushioning property and to show insufficient permeability with respect to the ink. In contrast, the micropores, if having an excessively large size, may cause the ink to diffuse excessively or may impede the formation of a fine wiring.

The porous layer has an average rate of inner pore area (porosity) of typically from 30% to 80%, preferably from 40% to 80%, and more preferably from 45% to 80%. The porous layer, if having a porosity out of the above range, may be difficult to exhibit desired pore properties according to the intended use. Typically, the porous layer, if having an excessively low porosity, may have insufficient cushioning properties or may impede ink penetration; and the porous layer, if having an excessively high porosity, may show poor strength or poor folding endurance. The porous layer has a rate of surface pore area of typically about 48% or more (e.g., from about 48% to about 80%) and preferably from about 60% to about 80%. The porous layer, if having an excessively low rate of surface pore area, may not show sufficient permeation capability; and the porous layer, if having an excessively high rate of surface pore area, may often show insufficient strength and poor folding endurance. The porous layer may have been treated so as to have chemical resistance. In addition or alternatively, the porous layer may be covered with a chemically-resistant polymer.

Exemplary polymer components as materials for constituting the porous layer include plastics such as polyimide resins, polyamideimide resins, poly(ether sulfone) resins, poly(ether imide) resins, polycarbonate resins, poly(phenylene sulfide) resins, liquid crystalline polyester resins, aromatic polyamide resins, polyamide resins, polybenzoxazole resins, polybenzimidazole resins, polybenzothiazole resins, polysulfone resins, cellulose resins, and acrylic resins. Each of different polymer components may be used alone or in combination. In addition or alternatively, copolymers (e.g., graft polymers, block copolymers, and random copolymers) of the above resins may also be used alone or in combination. Polymerized products each containing the skeleton (polymer chain) of any of the resins in a principal chain or side chain may also be used herein. Specific examples of such polymerized products include polysiloxane-containing polyimides each containing skeletons of polysiloxane and polyimide in a principal chain. Among them, preferred examples of polymer components for constituting the porous layer include those each mainly containing a polyamideimide resin or polyimide resin which has satisfactory thermal stability and excels in mechanical strength, chemical resistance, and electric properties.

The opto-electric hybrid circuit board may for example be prepared by casting a polymer solution into a film on a surface of the optical waveguide (hereinafter also simply referred to as “substrate”); introducing the work into a coagulation liquid; subsequently drying the work to form a porous layer on at least one side of the substrate to thereby give a porous film assembly; and forming an electric wiring on the surface of the porous layer of the porous film assembly.

The polymer solution to be cast may for example be a mixed solution containing the polymer component (or a precursor thereof) working as a material for constituting the porous layer; a water-soluble polymer; a water-soluble polar solvent; and, where necessary, water.

The presence of such water-soluble polymer and/or water in the polymer solution to be cast is effective for the film structure to be spongy and porous. Exemplary water-soluble polymers include polyethylene glycols, polyvinylpyrrolidones, poly(ethylene oxide)s, poly(vinyl alcohol)s, poly(acrylic acid)s, polysaccharides and derivatives thereof, and mixtures of them. Among them, polyvinylpyrrolidones are preferred for suppressing void formation in the film and for improving mechanical strengths of the film. Each of different water-soluble polymers may be used alone or in combination. For allowing the film to be porous satisfactorily, the water-soluble polymer has a molecular weight of preferably 200 or more, more preferably 300 or more, and particularly preferably 400 or more (e.g., from about 400 to about 20×10⁴). The water-soluble polymer may have a molecular weight of 1000 or more. The presence of water may allow the control of the void size. Typically, the polymer solution, when containing water in a larger amount, may give voids with larger sizes.

Exemplary water-soluble polar solvents include dimethyl sulfoxide, N,N-dimethylformamide, N,N-dimethylacetamide (DMAc), N-methyl-2-pyrrolidone (NMP), 2-pyrrolidone, and mixtures of them. Of such solvents, those having a solubility corresponding to the chemical skeleton of the resin used as the polymer component (i.e., good solvent for the polymer component) may be used herein.

Preferred examples as the polymer solution to be cast include a mixed solution containing 8 to 25 percent by weight of a polymer component working as a material constituting the porous film, 5 to 50 percent by weight of a water-soluble polymer, 0 to 10 percent by weight of water, and 30 to 82 percent by weight of a water-soluble polar solvent. The polymer component, if contained in an excessively low concentration, may cause the porous layer to have an excessively small thickness or may often impair desired pore properties of the porous layer. In contrast, the polymer component, if contained in an excessively high concentration, may often cause the porous layer to have a lower porosity. The water-soluble polymer is added so as to allow the porous film (porous layer) to have a uniform spongy porous structure inside thereof. The water-soluble polymer, if contained in an excessively low concentration, may cause the formation of huge voids typically of more than 10 μm in size inside of the film, thus resulting in poor uniformity of the film. In contrast, the water-soluble polymer, if contained in an excessively high concentration, may show poor solubility; and, if contained in a concentration of more than 50 percent by weight, may often cause problems such as weak film strength. The void size may be controlled by the amount of water. Typically, water, when used in a larger amount, may allow voids to have larger sizes.

When the polymer solution is cast as a film, the cast film is preferably maintained in an atmosphere at a temperature of from 15° C. to 100° C. and relative humidity of from 70% to 100% for 0.2 to 15 minutes, and then introduced into a coagulation liquid composed of a non-solvent with respect to the polymer component. The cast film (film-shaped polymer solution), when being maintained under the above conditions, may give a porous layer which has a uniform and highly continuous porous structure. This is probably because, by maintaining under humid conditions, water migrates into the film from surface to inside thereof and thereby efficiently promotes the phase separation of the polymer solution. The cast film is particularly preferably maintained at a temperature of from 30° C. to 80° C. and relative humidity of from 90% to 100% and most preferably maintained at a temperature of from 40° C. to 70° C. and relative humidity of about 100% (e.g., from 95% to 100%). If the cast film is placed under conditions of atmospheric humidity of less than the above range, the resulting porous layer may suffer from a trouble of insufficient rate of surface pore area.

The process allows the formation of a porous layer including a multiplicity of continuous micropores having an average pore size of from 0.01 to 10 μm. The pore size of micropores, porosity, and rate of surface pore area of the porous layer constituting the porous film assembly may be regulated to desired values by choosing or setting conditions such as types and amounts of components of the polymer solution, amount of water, and humidity, temperature, and time of casting.

The coagulation liquid for use in the phase conversion process has only to be a solvent that coagulates the polymer component and may be suitably selected according to the type of a polymer used as the polymer component. For example, when the polymer is a polyamideimide or polyamic acid, the coagulation liquid has only to be a solvent that coagulates the polyamideimide or polyamic acid, and examples thereof include water; alcohols including monohydric alcohols such as methanol and ethanol, and polyhydric alcohols such as glycerol; water-soluble polymers such as polyethylene glycols; mixtures of them; and other water-soluble coagulation liquids.

In the production process, a porous film assembly structurally including the substrate, and the porous layer directly arranged on a surface of the substrate is produced by introducing the cast film into a coagulation liquid to form a porous layer on the surface of the substrate, and subjecting the article directly to drying. The drying process is not limited, as long as being a process capable of removing the solvent component such as the coagulation liquid, and may be performed with heating or performed as natural drying at room temperature. The heating may be performed by any process or treatment that can control the temperature of the porous film assembly to a predetermined temperature, such as hot-air treatment, hot-roll treatment, or placing typically in a thermostat or oven. The heating temperature may be chosen within a wide range of from around room temperature to around 600° C. The heating may be performed in an air atmosphere or in an atmosphere of inert gas such as nitrogen gas. The use of air is most inexpensive in cost, but may invite an oxidation reaction. To avoid this, nitrogen or another inert gas is preferably used, of which nitrogen is advantageous in view of cost. The heating conditions may be suitably determined in consideration typically of productivity and properties of the porous layer and the substrate. After drying, a porous film assembly including the substrate and, present directly on a surface thereof, the porous layer is obtained.

An electric wiring may be formed on the surface of the porous layer of the porous film assembly by the above procedure such as plating, printing, or etching.

[Optically Transparent Sealants]

Sealing or encapsulating of optical semiconductor devices requires optically transparent sealants which excel in optical transparency, thermal stability, moisture resistance, adhesion, and cracking resistance. The cationically polymerizable resin compositions according to the present invention have these properties and are advantageously usable as optically transparent sealants for sealing of optical semiconductor devices.

[Nanoimprinting]

A processing method using a nanoimprinting technology is a technology which enables high-speed, inexpensive production of a fine structure having a pattern on the order of nanometers and which includes shorter processes with high productivity, and is thereby employed advantageously.

More specifically, the nanoimprinting is a technology in which a pattern is transferred by applying a photo-curable composition to a base or substrate, stamping an imprinting stamp (also called typically “mold” or “plate”) having a fine pattern onto the applied composition, and exposing and curing the stamped composition. Specifically, the nanoimprinting includes the following steps:

Step 1: Applying a photo-curable resin composition to a substrate to form an uncured film thereon;

Step 2: Heating the uncured film (film material) to a temperature of from the glass transition temperature (Tg) of the resin composition to around the softening point thereof to soften the resin, and at this time point, stamping an imprinting stamp bearing a fine pattern onto the softened resin to transfer the pattern thereto

Step 3: Subjecting the film material bearing the transferred fine pattern to cooling or photo-curing

Step 4: Removing the imprinting stamp and thereby obtaining an imprinted fine structure

A cationically polymerizable resin composition according to an embodiment of the present invention may give a fine pattern through nanoimprinting. The cationically polymerizable resin composition for nanoimprinting use may further contain customarily known additives according to necessity, such as photosensitizers, resins, adhesion improvers, reinforcers, softeners, plasticizer, viscosity modifiers, and solvents.

Cationically polymerizable resin compositions according to embodiments of the present invention are rapidly cured upon irradiation with light and thereby show high productivity. They give cured products from which an imprinting stamp can be easily removed, because the cured products are flexible and can satisfactorily bend upon the removal of the imprinting stamp. In addition, the resin compositions can each give a fine structure bearing a fine pattern on the order of nanometers which is reproduced in exact, because the cured product thereof can recover its original shape upon removal of the imprinting stamp. The resulting fine structure excels in properties such as optical transparency and thermal stability.

### EXAMPLES

The present invention will be illustrated in further detail with reference to several working examples below. It should be noted, however, that these examples are never construed to limit the scope of the present invention.

### Synthesis Example 1

A mixture (280 mL) of 24.9 g (0.23 mol) of sodium carbonate with toluene was heated to 95° C., combined with 1.4 g of propionic acid, and, while maintaining to 95° C., combined with 16 g of vinyl acetate added dropwise, and 15 minutes later, combined with 1.27 g (1.9 mmol) of di-μ-chlorobis(1,5-cyclooctadiene)diiridium(I) [Ir(cod)Cl]₂. Next, the mixture was combined with 40 g (0.19 mol) of oxetane-3,3-dimethanol added dropwise over 3 hours, followed by a reaction in a nitrogen atmosphere while adding dropwise 79.8 g of vinyl acetate thereto and maintaining the reaction temperature to 95° C. After the completion of dropwise addition, the reaction mixture was stirred for 1 hour. The resulting reaction mixture was analyzed by gas chromatography and found that there were formed 3,3-bis(vinyloxymethyl)oxetane represented by following Formula (13) in a yield of 90% and (3-vinyloxymethyloxetan-3-yl)methanol in a yield of 2%. The reaction mixture was purified by distillation and thereby yielded 31 g of 3,3-bis(vinyloxymethyl)oxetane with a purity of 99%.

¹H-NMR (CDCl₃) δ: 6.5 (2H, dd), 4.53 (4H, s), 4.2 (2H, d), 4.05 (2H, d), 3.93 (4H, s)

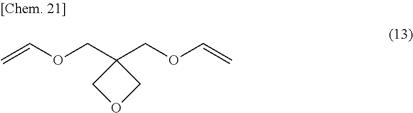

### Synthesis Example 2

Toluene (500 g) was added with 3-chloromethyl-3-ethyloxetane (0.1 mol), 1,4-cyclohexanediol (0.5 mol), and tetrabutylammonium bromide (0.01 mol). After being heated to 90° C., the mixture was combined with a 5N NaOH aqueous solution (100 g) added dropwise, followed by stirring for 5 hours. The toluene solution (toluene layer) was washed with water, concentrated, purified by silica gel chromatography, and thereby yielded 4-(3-ethyloxetan-3-yl-methoxy)cyclohexanol with a purity of 99%.

Independently, a mixture (100 mL) of sodium carbonate (0.06 mol) with toluene was heated to 95° C. While maintaining the temperature to 95° C., 4.2 g of vinyl acetate was added dropwise, and, 15 minutes later, di-μ-chlorobis(1,5-cyclooctadiene)diiridium(I) [Ir(cod)Cl]₂ (0.5 mmol) was added. Next, 4-(3-ethyloxetan-3-yl-methoxy)cyclohexanol (0.05 mol) was added dropwise over 2 hours, followed by performing a reaction in a nitrogen atmosphere while adding 12.6 g of vinyl acetate dropwise and maintaining the reaction temperature to 95° C. After the completion of dropwise addition, the reaction mixture was stirred for 1 hour, analyzed by gas chromatography, and found that 3-ethyl-3-(4-vinyloxycyclohexyloxymethyl)oxetane represented by following Formula (14) was formed in a yield of 92%. This was subjected to a ¹H-NMR (CDCl₃) measurement and found that signals specific to vinyl group were observed at 6.5 ppm, 4.2 ppm, and 4.04 ppm, as in Synthesis Example 1.

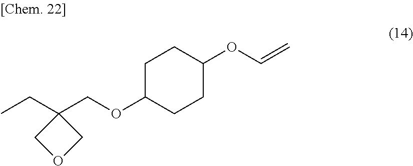

### Synthesis Example 3

Epoxidation of 12.6 g (0.1 mol) of (4-methylcyclohex-3-enyl)methanol was performed with a 5 percent by weight peroxyacetic acid-ethyl acetate solution at 65° C. The epoxidized product was purified by distillation and thereby yielded 12 g of (6-methyl-7-oxabicyclo[4.1.0]hept-3-yl)methanol with a purity of 98%.

Independently, a mixture (100 mL) of sodium carbonate (0.06 mol) with toluene was heated to 95° C. While maintaining the temperature to 95° C., 4.2 g of vinyl acetate was added dropwise, and, 15 minutes later, di-μ-chlorobis(1,5-cyclooctadiene)diiridium(I) [Ir(cod)Cl]₂ (0.5 mmol) was added. Next, (6-methyl-7-oxabicyclo[4.1.0]hept-3-yl)methanol (0.05 mol) was added dropwise thereto over 2 hours, followed by performing a reaction in a nitrogen atmosphere while adding 12.6 g of vinyl acetate dropwise and maintaining the reaction temperature to 95° C. After the completion of dropwise addition, the reaction mixture was stirred for 1 hour, analyzed by gas chromatography, and found that 1-methyl-4-vinyloxy-7-oxabicyclo[4.1.0]heptane represented by following Formula (15) was formed in a yield of 95%. This was subjected to a ¹H-NMR (CDCl₃) measurement and found that signals specific to vinyl group were observed at 6.5 ppm, 4.2 ppm, and 4.05 ppm, as in Synthesis Example 1.

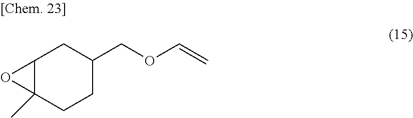

### Synthesis Example 4

Toluene (500 g) was added with 4-chloromethylcyclohexene (0.1 mol), 1,4-cyclohexanediol (0.5 mol), and tetrabutylammonium bromide (0.01 mol). After being heated to 90° C., the mixture was combined with a 5N NaOH aqueous solution (100 g) added dropwise, followed by stirring for 5 hours. The toluene solution (toluene layer) was washed with water, concentrated, purified by silica gel chromatography, and thereby yielded 13 g of 4-(cyclohex-3-enylmethoxy)cyclohexanol with a purity of 99%.

The produced 4-(cyclohex-3-enylmethoxy)cyclohexanol was epoxidized by the procedure of Synthesis Example 3 and thereby yielded 8 g of 4-(7-oxabicyclo[4.1.0]hept-3-ylmethoxy)cyclohexanol.

Next, vinyl-etherification was performed by the procedure of Synthesis Example 3, except for using the above-prepared 4-(7-oxabicyclo[4.1.0]hept-3-ylmethoxy)cyclohexanol instead of (6-methyl-7-oxabicyclo[4.1.0]hept-3-yl)methanol, and thereby yielded 3-(4-vinyloxycyclohexyloxymethyl)-7-oxabicyclo[4.1.0]heptane represented by following Formula (16). This was subjected to a ¹H-NMR (CDCl₃) measurement and found that signals specific to vinyl group were observed at 6.5 ppm, 4.2 ppm, and 4.04 ppm, as in Synthesis Example 1.

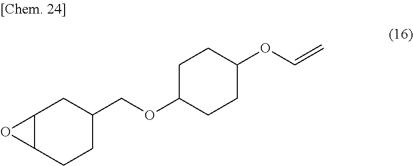

### Examples 1 to 5 and Comparative Examples 1 to 10

### Cured Products of Cationically Polymerizable Resin Compositions

A series of cationically polymerizable resin compositions was prepared by mixing and dissolving a vinyl ether compound, an oligomer or polymer, an oxetane compound, another curable compound, and a photo-induced cationic polymerization initiator in types and amounts (parts by weight) given in Table 1.

A portion corresponding to a sample shape (15 mm wide and 60 mm long) was cut out from a Teflon® plate having a thickness of 1 mm or 200 μm, and the residual Teflon® plate was sandwiched between two plies of a PET film being coated with Teflon® on one side thereof, then further sandwiched between two plies of a glass plate, and thereby yielded an assembly [(glass plate)/PET/(Teflon® plate)/PET/(glass plate)].

Each of the above-prepared cationically polymerizable resin compositions was injected into the sample-shaped cut-out portion with an injector and then irradiated with an ultraviolet ray (UV) under conditions mentioned below using a conveyer-type ultraviolet irradiator to form a series of cured products each having a thickness (1 mm or 200 μm) corresponding to the Teflon® plate used.

The curing rate of the obtained cationically polymerizable resin compositions, and the gel fraction, curing rate, initial optical loss, post-heating optical loss, bendability (flexibility), thermal stability, thermal decomposition temperature, and post-heating bendability of the obtained cured products were measured or determined according to the following methods. The results are shown in Table 1.

UV Curing Conditions:
UV irradiator: trade name “UVC-02516S1AA02” (supplied by Ushio Inc.)

Metal Halide Lamp
Irradiation condition: 160 W
Conveyor speed: 2 m/min
Number of irradiation pass: 1

Reference signs indicating the vinyl ether compounds, oligomers or polymers, oxetane compounds, other curable compounds, and photo-induced cationic polymerization initiators in Table 1 are as follows:

[Vinyl Ether Compounds]
(A1): 3,3-Bis(vinyloxymethyl)oxetane obtained from Synthesis Example 1
(A2): 3-Ethyl-3-(4-vinyloxycyclohexyloxymethyl)oxetane obtained from Synthesis Example 2
(B1): 1-Methyl-4-vinyloxy-7-oxabicyclo[4.1.0]heptane obtained from Synthesis Example 3
(B2): 3-(4-Vinyloxycyclohexyloxymethyl)-7-oxabicyclo[4.1.0]heptane obtained from Synthesis Example 4
(X): 1,4-Cyclohexanedimethanol divinyl ether (supplied by Aldrich (now part of Sigma-Aldrich Corporation))

[Oligomers or Polymers]
(PB3600): Epoxidized polybutadiene having hydroxyl groups at both terminals (trade name “PB3600”, supplied by Daicel Chemical Industries, Ltd.)
(CD220PL): Polycarbonatediol (trade name “CD220PL”, supplied by Daicel Chemical Industries, Ltd.)

[Oxetane Compounds]
(OXT-213): 3-Ethyl-3-(cyclohexyloxymethyl)oxetane (trade name “OXT-213”, supplied by Toagosei Co., Ltd.)
(OXT-212): 3-Ethyl-3-(2-ethylhexyloxymethyl)oxetane (trade name “OXT-212”, supplied by Toagosei Co., Ltd.)

[Other Curable Compounds]
(CELLOXIDE 2021P): Cyclic ether compound (trade name “CELLOXIDE 2021P”, supplied by Daicel Chemical Industries, Ltd.)

[Photo-Induced Cationic Polymerization Initiators]
(Irgacure 250): trade name “Irgacure 250” (supplied by Ciba Japan (now part of BASF Japan Ltd.)):

### Evaluation Tests

(Gel Fraction)

Each of the cured products having a thickness of 200 μm obtained from the examples and comparative examples was placed in methyl ethyl ketone as a solvent, and the initial weight of the sample before extraction, and the weight of the sample after extraction and drying were measured, and the gel fraction of the sample was calculated according to the following expression:

Gel fraction (%)=(Weight after extraction and drying)/(Initial weight before extraction)×100

(Curing Rate)

Each of the cationically polymerizable resin compositions obtained from the examples and comparative examples was irradiated with an ultraviolet ray using the belt conveyor, and how the sample was cured was evaluated according to the following criteria.

Evaluation Criteria:
Sample gave a cured product: Good
Sample was highly viscous and was not cured (solidified): Poor

(Initial Optical Loss and Post-Heating Optical Loss)

Each of the cured product having a thickness of 1 mm obtained from the examples and comparative examples was diced to a width of 1 mm and thereby yielded a series of samples for optical loss measurement. Light was allowed to enter each sample immediately after curing (“initial”) and after a heating treatment at 200° C. for 1 hour (“post-heating”) from a light source at a wavelength of 850 nm through the cutback technique using a polymer-clad fiber (PCF), and light from the sample was received with a detector having a detecting unit of 5 mm in diameter, and an optical loss (dB/cm) was measured.

(Bendability)

Each of the cured products having a thickness of 200 μm obtained from the examples and comparative examples was placed around a rod 2 mm in diameter, whether the sample cured product showed cracking or not was visually observed, and the bendability of the sample was evaluated according to the following criteria.

Evaluation Criteria:
Sample showed no cracking: Good
Sample showed cracking: Poor

(Thermal Stability)

Each of the cured products having a thickness of 200 μm obtained from the examples and comparative examples was subjected to a heating treatment in an oven at 200° C. for 2 hours, the change in weight (weight loss percentage) of each sample was measured between before and after the heating treatment, and the thermal stability was evaluated according to the following criteria.

Evaluation Criteria:
Sample had a change in weight of 50 or less: Good
Sample had a change in weight of more than 5% but 10% or less: Fair
Sample had a change in weight of more than 100: Poor

(Thermal Decomposition Temperature)

The thermal decomposition temperature top peak of each of the sample cured products having a thickness of 200 μm obtained from the examples and comparative examples was measured by differential scanning calorimetry (DSC), and the thermal decomposition temperature was evaluated according to the following criteria.

Evaluation Criteria:
Sample had a decomposition temperature top peak of 300° C. or higher: Good
Sample had a decomposition temperature top peak of lower than 300° C.: Poor

(Post-Heating Bendability)

Each of the cured products having a thickness of 200 μm obtained from the examples and comparative examples was subjected to a heating treatment in an oven at 200° C. for 1 hour, and this was placed around a rod 2 mm in diameter, whether the sample cured product showed cracking or not was visually observed, and the (post-heating) bendability of the sample was evaluated according to the following criteria.

Evaluation Criteria:
Sample showed no cracking: Good
Sample showed cracking: Poor

TABLE 1

| | | Examples | | | | | Comparative Examples | | | | | | | | | |
|---|---|---|---|---|---|---|---|---|---|---|---|---|---|---|---|---|
| | | 1 | 2 | 3 | 4 | 5 | 1 | 2 | 3 | 4 | 5 | 6 | 7 | 8 | 9 | 10 |
| Cationically | Vinyl ether | | | | | | | | | | | | | | | |
| polymerizable | compound | | | | | | | | | | | | | | | |
| resin | A1 | 30 | 30 | | | | 70 | 70 | | | | 100 | 70 | | | |
| composition | A2 | | | 40 | | | | | 70 | | | | | | | |
| | B1 | | | | 40 | | | | | 70 | | | | | | |
| | B2 | | | | | 40 | | | | | 70 | | | | | |
| | X | | | | | | | | | | | | | 70 | 70 | 30 |
| | Oligomer or | | | | | | | | | | | | | | | |
| | polymer | | | | | | | | | | | | | | | |
| | PB3600 | 30 | 30 | 30 | 30 | 30 | | 30 | 30 | 30 | 30 | | | 30 | | |
| | CD220PL | | | | | | 30 | | | | | | | | 30 | |
| | CELLOXIDE | | | | | | | | | | | | 30 | | | 70 |
| | 2021P | | | | | | | | | | | | | | | |
| | Oxetane | | | | | | | | | | | | | | | |
| | compound | | | | | | | | | | | | | | | |
| | OXT-213 | 40 | | 30 | 30 | 30 | | | | | | | | | | |
| | OXT-212 | | 40 | | | | | | | | | | | | | |
| | Photo-cationic | | | | | | | | | | | | | | | |
| | light- | | | | | | | | | | | | | | | |
| | activatable | | | | | | | | | | | | | | | |
| | acid | | | | | | | | | | | | | | | |
| | generator | | | | | | | | | | | | | | | |
| | Irgacure 250 | 5 | 5 | 5 | 5 | 5 | 5 | 5 | 5 | 5 | 5 | 5 | 5 | 5 | 5 | 5 |

| | | | | | | | | | | | | | | | |
|---|---|---|---|---|---|---|---|---|---|---|---|---|---|---|---|
| Initial optical loss (dB/cm) | 0.08 | 0.09 | 0.08 | 0.09 | 0.09 | 0.1 | 0.08 | 0.09 | 0.1 | 0.09 | 0.09 | 0.1 | 0.3 | 0.27 | un- |
| | | | | | | | | | | | | | | | measurable |
| Post-heating optical loss | 0.09 | 0.1 | 0.09 | 0.1 | 0.1 | 0.12 | 0.09 | 0.1 | 0.1 | 0.1 | 0.1 | 0.11 | >1 | >1 | un- |
| (dB/cm) | | | | | | | | | | | | | | | measurable |
| Bendability | Good | Good | Good | Good | Good | Good | Good | Good | Good | Good | Poor | Poor | Good | Good | un- |
| | | | | | | | | | | | | | | | measurable |
| Gel fraction (%) | 96 | 96 | 96 | 95 | 95 | 95 | 96 | 96 | 94 | 95 | 95 | 91 | 92 | 92 | gelatinous |
| Curing rate | Good | Good | Good | Good | Good | Good | Good | Good | Good | Good | Good | Good | Good | Good | Poor |
| Thermal stability | Good | Good | Good | Good | Good | Good | Good | Good | Good | Good | Good | Good | Poor | Poor | — |
| (weight loss upon heating) | | | | | | | | | | | | | | | |
| Thermal decomposition | Good | Good | Good | Good | Good | Good | Good | Good | Good | Good | Good | Good | Poor | Poor | — |
| temperature | | | | | | | | | | | | | | | |
| Post-heating bendability | Good | Good | Good | Good | Good | Poor | Poor | Poor | Poor | Poor | Poor | Poor | Poor | Poor | — |

Table 1 demonstrates as follows. The cationically polymerizable resin compositions according to the present invention each had a gel fraction of 94% or more, indicating that they are highly reactive. In addition, they excelled in thermal stability, flexibility, and post-heating bendability, and resist increase in optical loss due to heating. In contrast, samples using no oxetane compound (D) containing no vinyl ether group and having 6 or more carbon atoms had poor post-heating bendability. Samples using, as an oligomer or polymer, no oligomer or polymer (C) as specified in the present invention showed poor flexibility. Samples using a vinyl ether compound other than the oxetane-ring-containing vinyl ether compound (A) and other than the alicyclic-epoxy-group-containing vinyl ether compound (B) had poor optical transparency, thereby showed a large initial optical loss, and, in addition, showed a further larger post-heating optical loss because of their poor thermal stability.

### Example 6

### Opto-Electric Hybrid Circuit Board

A cationically polymerizable resin composition according to Example 2 in Table 1 was prepared. This composition contained Compound A1, PB3600, OXT-212, Irgacure 250 in amounts of 30 parts by weight, 30 parts by weight, 40 parts by weight, and 5 parts by weight, respectively.

The prepared cationically polymerizable resin composition was applied to a film carrier so as to give a cured product 60 μm thick, the applied composition was irradiated with an ultraviolet ray under conditions mentioned below using a conveyor-type ultraviolet irradiator, and thereby yielded a base film for waveguide clad.

Next, another composition was prepared by mixing and dissolving 30 parts by weight of Vinyl Ether Compound A1, 20 parts by weight of the epoxidized polybutadiene (PB3600), 20 parts by weight of the oxetane compound (OXT-212), 5 parts by weight of the acid generator (Irgacure 250), and 30 parts by weight of a high-refractive-index material (1-acryloxy-4-methoxynaphthalene, supplied by Kawasaki Kasei Chemicals Ltd.). This composition was applied to the above-prepared base film for waveguide clad, subjected to photolithography according to a customary procedure, and thereby yielded a core having a thickness of 60 μm and a width of 60 μm.

Next, the cationically polymerizable resin composition used for the preparation of the base film for waveguide clad was applied to a region other than the core to a thickness of its cured product of 60 μm (the same as the thickness of the core), and another ply of the above-prepared base film for waveguide clad was affixed to the resulting article to give an assembly including two plies of the base film for waveguide clad, and the core sandwiched between them. This was irradiated with an ultraviolet ray under conditions mentioned below using the conveyor-type ultraviolet irradiator and thereby yielded a waveguide.

Ultraviolet Curing Conditions:
Ultraviolet irradiator: trade name “UVC-02516S1AA02”(supplied by Ushio Inc.)

Metal Halide Lamp
Irradiation condition: 160 W
Conveyor speed: 2 m/min
Number of irradiation pass: 1

A filming dope was prepared by adding 30 parts by weight of a polyvinylpyrrolidone (having a molecular weight of 5×10⁴) as a water-soluble polymer to 100 parts by weight of a polyamideimide resin solution (trade name “VYLOMAX HR11NN” supplied by Toyobo Co. Ltd.; solids concentration: 15 percent by weight, solvent: NMP, solution viscosity: 20 dPa·s at 25° C.). Independently, an optical waveguide (substrate) was prepared by removing the film carrier from the above-prepared waveguide, and the dope was adjusted to 25° C. and cast onto the optical waveguide using a film applicator so that a gap between the film applicator and the substrate be 51 μm. Immediately after casting, the article was held in a vessel at humidity of about 100% and a temperature of 50° C. for 4 minutes. The cast film was immersed in water and thereby solidified, then air-dried at room temperature without peeling off from the substrate, and thereby yielded an assembly including the substrate and a porous layer laminated thereon. The porous layer has a thickness of about 20 μm, and the assembly had a total thickness of about 120 μm.

This assembly was observed under an electron microscope and found that the porous layer was in intimate contact with the clad layer of the optical waveguide; pores present in the surface of the porous layer had an average pore size of about 1.0 μm; and, the inside of the porous layer was substantially uniform, with continuous (communicating) micropores having an average pore size of about 1.0 μm being present over the entire inside. The porous layer had an inner porosity of 70%.

The assembly was printed through screen printing with an electroconductive ink (silver paste supplied by Fujikura Kasei Co., Ltd. under the trade name “NANO DOTITE XA9053”; in which silver oxide is reduced by heating into silver). A screen printing machine LS-25TVA supplied by Newlong Seimitsu Kogyo Co., Ltd. was used herein. A line-and-space wiring pattern with 20-μm lines and 20-μm spaces was printed. The printing was performed at a speed of 30 mm/sec at an applied pressure of 0.1 MPa. After printing, the article was held at 180° C. for 30 minutes to cure the electroconductive ink and thereby yielded a wiring. The wiring appeared black immediately after printing but appeared glossy as metal silver after heating. An observation under an electron microscope revealed that a line-and-space wiring pattern with 20-μm lines and 20-μm spaces was formed.

### INDUSTRIAL APPLICABILITY

The cationically polymerizable resin compositions according to the present invention each have a low viscosity, are easy to work, are extremely rapidly cured upon irradiation with light, and give cured products which excel in optical transparency, flexibility, thermal stability, and post-heating bendability. The cationically polymerizable resin compositions and cured products thereof are therefore useful typically in optical fibers, optically transparent sealants, ink-jet inks, color filters, nanoimprinting technologies, and flexible boards and particularly useful in flexible optical waveguides, optically transparent sealants, and nanoimprinting technologies.

1. A cationically polymerizable resin composition comprising a vinyl ether compound (A) and/or a vinyl ether compound (B), the vinyl ether compound (A) containing an oxetane ring, and the vinyl ether compound (B) containing an alicyclic epoxy group; an oligomer or polymer (C) having a molecular weight of 500 or more and containing at least one selected from the group consisting of oxetane group, epoxy group, hydroxyl group, vinyl ether group, and an aliphatic or alicyclic unsaturated hydrocarbon group in the molecule; and an oxetane compound (D) containing no vinyl ether group and having 6 or more carbon atoms.

2. The cationically polymerizable resin composition according to claim 1, wherein the oligomer or polymer (C) is an oligomer or polymer containing a terminal hydroxyl group or a terminal hydrogen atom, having a molecular weight of 500 or more, and comprising at least one structure selected from the group consisting of structures represented by following Formulae (1a), (1b), (1c), and (1d): 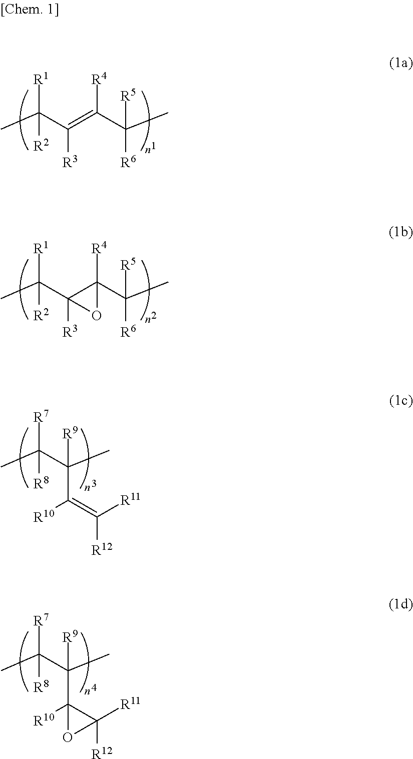
wherein R¹, R², R³, R⁴, R⁵, R⁶, R⁷, R⁸, R⁹, R¹⁰, R¹¹, and R¹² each represent a hydrogen atom or a substituted or unsubstituted hydrocarbon group having 1 to 20 carbon atoms; and n¹, n², n³, and n⁴ each denote an integer of 1 or more,
or the oligomer or polymer (C) is an oligomer or polymer containing a terminal hydroxyl group or a terminal hydrogen atom, having a molecular weight of 500 or more, and comprising a structure represented by following Formula (1e): 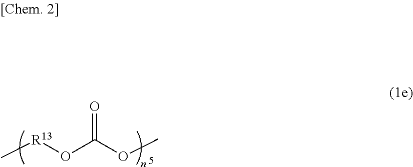
wherein R¹³ represents a substituted or unsubstituted divalent hydrocarbon group; and n⁵ denotes an integer of 1 or more.

3. The cationically polymerizable resin composition according to claim 1 or 2, wherein the oligomer or polymer (C) has at least an epoxy group and an aliphatic or alicyclic unsaturated hydrocarbon group.

4. The cationically polymerizable resin composition according to claim 1 or 2, wherein the oligomer or polymer (C) is a polycarbonate polyol, or an epoxidized polybutadiene having hydroxyl groups at both terminals.

5. The cationically polymerizable resin composition according to claim 1, wherein the oxetane compound (D) containing no vinyl ether group and having 6 or more carbon atoms is a compound represented by following Formula (2): 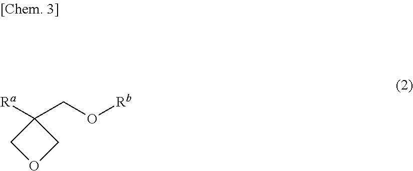
wherein R^{a} represents a hydrocarbon group; and R^{b} represents a hydrocarbon group other than a vinyl group.

6. The cationically polymerizable resin composition according to claim 1, for use in the production of an optical waveguide.

7. The cationically polymerizable resin composition according to claim 1, for use in or as an optically transparent sealant.

8. The cationically polymerizable resin composition according to claim 1, for use in nanoimprinting.

9. A cured product obtained through polymerization of the cationically polymerizable resin composition of claim 1.

10. The cured product according to claim 9, which forms a clad and/or a core of an optical waveguide.

11. A method for producing an optical waveguide, the method comprising the steps of applying the cationically polymerizable resin composition of claim 1 to a film to give a clad base film; and covering a core with the clad base film.

12. An optical waveguide produced by the method of claim 11.

13. An opto-electric hybrid circuit board comprising the optical waveguide of claim 12; and an electric wiring present on or above at least one surface of the optical waveguide.

14. An opto-electric hybrid circuit board comprising the optical waveguide of claim 12; an electric wiring; and a porous layer present between the optical waveguide and the electric wiring.

15. The opto-electric hybrid circuit board according to claim 14, wherein the porous layer is a porous layer prepared by casting a polymer solution as a film onto a substrate; introducing the cast film into a coagulation liquid to coagulate the cast film; and drying the coagulated film.

16. The opto-electric hybrid circuit board according to any one of claims 13 to 15, wherein the electric wiring has been foamed through plating, printing, or etching.

17. A method for producing a fine structure, the method comprising the step of subjecting the cationically polymerizable resin composition of claim 1 to nanoimprinting.
